(19) United States
(12) Patent Application Publication
(10) Pub. No.: US 2011/0060895 A1
(43) Pub. Date: Mar. 10, 2011

(54) System and methods for generating and organizing modular program code components

(76) Inventor: Neal Solomon, Oakland, CA (US)

(21) Appl. No.: 12/807,533

(22) Filed: Sep. 8, 2010

Related U.S. Application Data
(60) Provisional application No. 61/276,182, filed on Sep. 9, 2009.

(51) Int. Cl. G06F 9/00

(52) U.S. Cl. 713/1

(57) ABSTRACT

Modular program code is comprised of software blocks and software elements. Software modules self-configure to solve computer network problems. Software modules are applied to the organization and management of data objects in databases and in computer networks. The modular program code components self-assemble to solve problems in computer networks in real time using metaheuristics and modeling.

### CROSS-REFERENCES TO RELATED APPLICATIONS

The present application claims the benefit of priority under 35 U.S.C. §119 from U.S. Provisional Patent Application Ser. No. 61/276,182, filed Sep. 9, 2009, the disclosure of which is hereby incorporated by reference in their entirety for all purposes.

### FIELD OF THE INVENTION

The invention involves modular program code that is integrated into multiple software languages and hardware platforms and is involved with network computing and communications systems. The system uses program code blocks and elements that self-assemble in order to solve problems in real time by using analytics and modeling. A modular software computing system is self-organizing and embodies plasticity and evolutionary behaviors. Modular program code is used in automating computing functions and facilitates bio-inspired computing processes.

### BACKGROUND OF THE INVENTION

As computing networks become increasingly complex, new methods are sought to automate computing functions. In order to facilitate the automation of computer functions, particularly in the network computing context, scientists are looking to nature, and specifically to biology, for ideas. Bio-inspired computing provides several analogies to improve and automate computer systems. These include molecular and organic chemistry, genetic biology and proteomics. Scientific discoveries in these fields have applications to computer systems.

In the case of biological analogies to computer systems, the use of large and small molecules in molecular networks is an analogy for the present system. In this chemical system, molecules are recruited to solve a problem in nature. DNA is a biochemical system for the storage and activation of genes that perform specific functions. Further, RNA is a mechanism for replacement of genes to perform failsafe activation of functional processes. Similarly, genetics provides a system for the generation of proteins to interoperate in protein networks to solve biological problems.

The human immune system provides another exam* of a natural system in which antibody collectives are recruited when a threshold is achieved in order to attack an invading antigen. Very complex problems, such as a new virus, are solved by the adaptive immune system by using unique cells that pass immunity to memory for future solution generation.

Similarly, protein networks are used to activate a specific set of proteins to release new proteins to solve a problem. In some cases, this process is accelerated by the use of enzymes.

More fundamentally, the field of chemistry is used as an analogy of a system that uses modular components that are rearranged to perform specific functions. The addition and subtraction of atoms as components for chemical cores, in which the atoms are bonded to connect chemical structures, is a useful analogy for the present system. Further, chemicals interact with specific chemicals and transform chemical structures in physical processes. In particular, organic chemistry shows that small molecules influence biological behaviors in very complex systems.

Beyond the physical and biological sciences, language provides a further analogy to the present system. Words are built in sentence structures, with a translation of words between languages. Root words are ordered and reordered, with ontological reference of objects with language. Letters of the alphabet are aggregated into words and sentences of unique referential combinations. The slow transformation of language occurs with object-reference changes.

In computer science, quality of service (QoS) systems have some features of network security that involve network perimeter access limitations. Extreme Networks uses a simple pre-set modular operating system with a limited perimeter access to promote network security.

Arista Networks uses a simple view of modular code inside computer network routers. In this case, the system merely replaces a pre-programmed code module in a single fixed hardware component; in effect, the program code is simply reloaded when needed, like rebooting the software system or turning off and on a switch. This system uses no updated or evolving code. The system uses no new code to solve new problems. The system uses no mobile code (since it is fixed within a specific hardware component). The system has no code block components. The system merely replaces modules and integrates into an operating system with messages.

IBM's autonomic computing technologies provide a background for the automation and self-organization of computer network operations using pre-programmed systems. However, this system does not have the flexibility to solve novel problems on-demand.

In U.S. Pat. No. 7,277,876, Solomon shows a T-STOR database that transforms the architecture of the database and in U.S. Pat. No. 7,526,460, Solomon shows the mobile hybrid software router in which multiple artificial intelligence techniques are combined to efficiently solve problems in computer networks. These patents illustrate a model for organizing program code. Further, Solomon has shown the use of IP core elements with application to complex programmable logic devices. The program code elements organize and reorganize to solve problems with applications to FPGAs.

### PROBLEMS THAT THE INVENTION SOLVES

The invention solves a set of problems involving the organization, filtration and storage of data objects. The invention facilitates the storage and access of object components in databases. The invention also solves problems involving the pruning of garbage program code. The invention solves problems involving malicious computer program code in order to secure a computer. The invention is involved in aggregating and reaggregating program code to solve a range of computer program organization and data organization, storage and access functions.

The invention solves problems involving network computing. The invention is involved in tasks and applications that involve multiple computers interoperating in a network environment, including security, efficiency optimization and plasticity dynamics operational maximization. The invention also applies to problems involving computer modeling of program code.

### SUMMARY OF THE INVENTION

The present invention involves (a) the organization of data objects in databases using program code modules, (b) the generation and organization of program code blocks and code elements into modules, (c) the use of code modules in computer networks, (d) the generation of solutions to modular code problems with advanced metaheuristics and (e) the modeling of solutions involving program code modules.

The organization of objects in databases involves the organization of program code modules for the aggregation and reaggregation of software components to optimize storage and retrieval operations. The invention describes memory optimization management involving program code components and solves software memory virtualization problems. Further, the invention shows uses of software module components for encryption by disaggregating components to increase security. Finally, the system optimizes complex video object storage and retrieval by aggregating components using software modules.

The generation and organization of program code blocks and code elements into modules is performed by aggregating code components as basic units. Software code components are organized into software modules for functional utility. Specifically, software code elements are used in a fine grained approach to generating software modules with particular applications. The invention shows how to reverse engineer missing code elements for specific applications. The invention shows how to update versions of program code and objects with code elements to efficiently solve problems. The invention uses techniques to eliminate unused object components using modular program code consisting of software blocks and elements. The system shows how to access software libraries to obtain and generate code modules and components. The system combines program code blocks and elements for self-assembly of software modules. The aggregation of program code elements activates software functionality on-demand. Not only is program code combined on-demand in the present system, but the system reaggregates the composition of program code with code elements for new uses. Finally, the invention describes ways of implementing program code modules in hardware.

The present invention further shows how to apply modular code to computer networks. The system solves allocation optimization problems with modular software. The system applies software modules to computer network hubs for maximized functionality. The system applies software modules to automate bandwidth modulation in computer networks. The system is applied to multiple parallel routers in a computer network. The system shows how to route modular software in a computer network. Finally, the system shows how software modules and components are circulated in a computer network for maximum functionality.

The invention optimizes the functional performance of software modules using metaheuristics. The system applies the ACO metaheuristic to modular software component collective behaviors. Swarm intelligence is applied to software module collectives. The invention shows how to self-organize object components with modular code. The invention shows how to reaggregate code blocks and elements using software module collective behaviors. Finally, plasticity behaviors are shown with software modules in computer networks.

The invention shows how to perform modeling of modular software components. The system provides analytical modeling of software module behaviors. The system also shows how to perform dynamic modeling of software module collective behaviors. The invention shows how to model modular software component behaviors with local search metaheuristics. Active modeling of interactions between software module behaviors and network computing architecture configurations are shown. Finally, the invention shows how modeling processes trigger computer network architecture plasticity.

### INNOVATIONS OF THE INVENTION

There are several applications of the present system. Modular software may be implemented in different hardware and software platforms. Regarding hardware, the present invention may be implemented in application specific integrated circuits, in CPLDs and FPGAs and in microprocessors with either the Von Neumann architecture or the Harvard architecture. Further, the present invention may be implemented in hybrid platforms, including system on a chip (SoC) and network on a chip (NoC) platforms, multi-core and 3D chips and in computer networks.

Regarding software, the present invention may be implemented in traditional programming languages, like Unix, C, C++, Java and XML as well as open source platforms. In effect, the present invention is a meta-architecture that is implemented in multiple languages. The present system allows the automation of program code that is not achievable in pre-programmed languages. The present modular approach is therefore useful for translating components of these lower level languages.

In computer networks, the present invention is used to solve routing optimization problems. The present system is useful for plugging in a specific module to complete an application.

The invention is used in several computing applications. It is useful for enterprise systems for integrating different components. It is useful for organizing and managing cloud computing, telecommunications networks, local area networks, intranets and server farms. It is useful for network management in network on a chip applications. It is useful for mobile device applications that involve location-specific and time-specific applications. It is useful in control system applications and digital signal processor applications. It is useful for video, multimedia and interactive video applications. Finally, it is useful for robotics and collective robotics systems.

### ADVANTAGES OF THE INVENTION

The invention has numerous advantages. The ability to use modular code for database management increases automation of database storage and retrieval functions. The increase in automation allows faster and more efficient database operations. The system also improves memory management functions. Further, the system increases database management efficiency while also maximizing flexibility.

The system allows increased analysis and solutions of optimization problems. By allowing the reusability of program code, by learning from earlier solutions and by employing a flexible software component solution approach, the present system automates the process of solving optimization problems. Further, because it is automated, efficient and flexible, the system integrates techniques for maximizing efficiency in computational systems, including the automation of processes to minimize junk code. The system applies computational economics to optimize software process operations.

In the context of network computing, the invention increases network optimization by constantly re-routing software components. By utilizing autonomous decentralized software module architectures, the system solves parallelization problems. The invention also facilitates the management of network traffic in a self-organizing system.

By allowing the software modules and software components to decentralize network computing functions, the network unit of control becomes the node. This approach therefore allows computing networks to remove layers of distributed computing function, such as hubs.

The system integrates artificial intelligence techniques to increase problem solving efficiencies. By using ACO, swarm intelligence and local search metaheuristics, the system is able to automatically perform environmental interaction, feedback and adaptation. These processes lead to network plasticity mechanisms.

Finally, the system uses modeling techniques to solve optimization problems on demand and to automatically implement solutions. These modeling solutions allow the system to integrate new program code components into novel configurations on-demand.

Ultimately, the system facilitates the genesis and management of an organic self-organizing modular software operating system across networks with multiple integrated applications.

### DESCRIPTION OF THE INVENTION

### (I) System and Methods for Managing Modular Program Code

Pre-programmed software has limitations. Deterministic software has the restrictions of legacy computer systems that constrain adaptation. As computer languages evolve, the requirements increasingly involve object-orientation, modularity, dynamism and architectural ubiquity. In effect, what is needed is a meta-language that integrates with programming level software architectures to implement modular program code in multiple programming languages.

While a modular software system is essential for operation in computer networks; and therefore requires elements of mobility and security, it is also essential for intra-node operation within a single chip, router or switch. The modular software system is an adaptive language in a complex system.

(1) Methods for Organization of Program Code Core and Code Elements into Software Modules

Modular software code consists of program code core and program code elements. Core code is blocks of program code that perform a specific function. Program core elements are small sequences of program code that combine together with other elements or core blocks to perform specific functionality. The program code core and elements are implemented a la carte. The combination of core blocks and elements generate software modules with particular functionality. The aggregation of specialized software modules creates a multifunctional software system. Because they are aggregated in different configurations, software modules are implemented in different sizes and functionality. Code cores and code elements represent basic building blocks for software functionality. Software modules are generated from code core and elements to satisfy functional requirements with different attributes on demand in a software system. One advantage of using modular program code is to replace or restore software modules that are not fully executing a program.

The present system uses software modules that are predetermined as well as those that are indeterminate. Preset modules have specific programmed functionality, much like an application specific integrated circuit. Once specific inputs are registered, the software module performs a function to obtain a specific output.

The present invention is also organized to have custom configured modular software. The code is designed on the fly to solve a novel problem. In this case, software components are generated from software modules to solve specific problems. Auto-generation of program code elements from software modules provides substantial system flexibility and complex functionality.

The main software program code core is a code block or set of blocks. Program code elements are a subsidiary code aspect attached to the block(s). While blocks are combined together to facilitate specific functionality in a software module, code elements are affixed to and combined with blocks in order to have functionality. A code element adds specific functionality to a block. The analogy of this approach can be drawn from organic chemistry and microbiology in which small molecules combine with large molecules to obtain specific functionality of the combined chemical unit. The code element(s) complete the specific functionality of a code block to form a software module.

(2) Methods for Organizing Blocks of Program Code into Software Modules

Program code blocks are organized into specific species and families. Common species members are compatible and interlocking. Each family block group focuses on specific task categories. This model of species and families of code blocks eliminates conflicts and increases compatibility and familiarity with similar block types to initiate and sustain a stable operating system substrate.

Code blocks are organized to solve specific optimization problems. When a system problem is discovered, specific code blocks are requested within a specific family category to solve a specific class of problem. Compatible code blocks are combined in unique configurations to solve unique problems. By combining pre-formed code blocks efficiently in modules, the system automates solutions to complex problems.

While some blocks are interchangeable, particularly within families, replacement blocks are used to provide new functionality. In these cases, a replacement block is a new version of the block family with new functionality (type 5.7 replaces type 5.5, for example). While all blocks have limited functionality, the replacement blocks represent a new version with increased functionality. In effect, the replacement of blocks updates the block it is replacing.

Updates of code blocks occur periodically as well as on-demand by the software system. Software code blocks are prioritized and reprioritized over time, particularly as new versions are available to replace and update older versions of code blocks. The replacement of code blocks with updated versions is an efficient way to reconfigure modular software.

While code blocks are pre-programmed and initiated by system administration, code blocks are also generated on-demand by the functional application. The active application attracts code blocks in an open request for blocks from code families that will solve a particular functional problem. For instance, a software module may have omitted a specific set of code blocks to complete a task. The software module then maintains an open order to request specific code blocks to complete the software module by combining the old and the new blocks into a new configuration to solve a particular problem.

Code sequences are combined with code connectors, which are conjunctions at points in program code sequences between specific components. Conjunctions connect the blocks and the elements. The conjunctions must be compatible between the connecting blocks and elements or the sequence components will be inactive.

In one implementation of the invention, open spaces are integrated into code sequences in order to allow the interjection of code blocks. Blank spaces are made available in blocks for insertion of code elements. These intentional blank spaces are intended to be used to modify any program code language structure. This idea is borrowed from the idea of “junk” or useless genes in DNA that have been generated over time to perform a function that is no longer applicable. The present system builds on the idea of junk code by intentionally creating blank spaces for the future insertion of code components. Blank spaces in code sequences are intended to allow the injection of specific code elements. These blank spaces are conjunction points.

Code elements are typically injected at the end of specific program code sequences. However, elements are injected between sequences of code as well as the end of blocks.

In an example of an application of software modules using code blocks, different programming languages may be translated by code blocks at specific junctions of the software module. While the whole language may not be effectively translated in real time, a sufficient amount of the translation may occur by accessing a table of interchangeable code by comparing ontologies and seeking relative equivalence. Though this model only works on the edges of program language translation, this may be sufficient to solve some problems in real-time involving two or more languages.

Further, the system is able to mix code blocks from different languages by using translation features at junctions to allow limited alien code interaction and functionality.

### (3) System and Methods for Generating Fine Grained Program Code Elements in Software Module

Program code elements are fine grained software micro-components affixed to program code blocks in software modules. One main feature that code elements provide to software modules is the ability to generate customized solutions to complex optimization problems. The main code core that consists of code blocks are supplemented by specific functionality of code elements. The elements provide the blocks with specific application functionality on-demand by supplying and activating specific features. One advantage of this model is the ability to add and subtract code as needed to solve evolving problems as the tasks progress without affecting the underlying superstructure of the software program.

Code elements are added to and subtracted from specific combinations of code blocks to generate and facilitate transformable code components. The code elements represent periphery components in complex assemblies of code blocks and elements. While code blocks represent a super structure for an application, elements are supplied on-demand for specific functionality. Though code elements are activated in a specific sequence, they are also organized to be activated out of a specific order so as to maximize efficiency. For example, the elements are affixed to blocks at specific locations, but may be activated in multiple sequences so as not to constrain their specific location.

### (4) Methods to Infer Missing Code Elements in Modular Software System for Specific Applications

Software modules consist of program code blocks and code elements. To determine the specific functionality of the modules, it is necessary to identify the composition, the configuration and the identity of the elements because the elements determine specific features and functionality.

Rather than only viewing the combination of elements with blocks as an additive process driven by a specific pre-programmed model, the present invention also develops a mechanism to work backwards to identify a specific functionality at an initial step and then reverse engineer the specific combination of elements required to complete this set of tasks. The system then constructs the specific elements by accessing a database to identify similar elements used in previous solutions. This inference approach is based on the use of a model to analyze the optimization problem and assess the solutions to the problem by generating a specific combination of application specific elements.

Program code elements are generated and combined with blocks to solve the problems. The solutions are assessed and new versions of elements are generated and implemented to improve the solutions until the problem is solved. In some cases, this approach involves applying elements in a new sequence.

The use of inference approaches to solve the optimization problem by generating program code elements involves the development of customized program code configured for each task.

(5) Methods for Updating Versions of Program Code and Objects with Program Code Elements

Program code blocks are activated in iterations. These versions of the blocks are constantly updated so as to preserve the latest and most effective program code details. The present invention facilitates the process of updating program code blocks by updating program code elements. The elements provide new code to the blocks to complete or update the program code to a new specification to solve a new set of problems. Each version of the software module adapts to specific applications. New code elements are generated by analyzing previous problems and integrating components of successful solutions. Each new version of a solution that is organized by adding new elements are advanced and tested to solve new problems beyond the old problems.

Similarly, data objects are updated by providing new data components with software modules that represent new versions of the objects. This layering approach to modifying objects is more efficient than replacing the object.

The use of new program code to update software module components by generating code elements is an efficient solution to the problem of updating program code for new applications without replacing the whole software system.

(6) Methods to eliminate unused object components with modular program code

Removing unused object components is a significant problem in computer systems. In order to maximize efficiency of computer system operations, it is necessary to select out unused object components. The modular software system disclosed in the invention is useful to accomplish the task of removing unused object components.

At periodic intervals, the system uses software modules to identify, assess and remove unused object components. Unused object components may consist of unused earlier versions of the object that become dead weight for the system. The modular program code uses blocks and elements to tag and assess the low priority of the earlier versions of the object and removes the low priority versions by placing these object components in a low priority location of a dbms. The modular software system constantly optimizes objects using this approach so as to maximize system efficiency.

Modular software identifies, assesses and removes the accumulation of junk code in the software system. The code blocks and elements combine to filter junk code. The filter is constantly updated with evolving protocols. As code is accessed by the filter, the low priority code is compared to protocols and either removed, updated or replaced.

Code blocks and elements are also applied to the modular software system itself This internal mechanism is organized to identify, assess and filter junk code blocks so as to constantly update the code blocks for maximum functionality. This internal operations control system acts as a filter to police the efficiency and effectiveness of software modules themselves.

Program code that creates conflicts with other code is identified by the internal policing capabilities of the modular software system. These conflicts between code blocks are assessed and the problems solved with addition of specific code elements from compatible families. This process is performed by comparing code structure and function in code libraries. Similarly, incomplete software modules are identified by software code blocks and the elements replaced with effective elements until the problems are solved.

The use of software modules to remove unused object components or to clear up ineffective code blocks represents an efficient self-cleaning process of the present invention. The software code monitoring of code operations is performed in regular intervals or upon demand by a software module application. The solution in most cases is to custom configure a new code element combination to maximize the performance of an application.

### (7) Method to Enable Code Elements to Access Code Libraries

The system uses libraries to access code elements. The libraries are provided within the database management system to which the software modules have access. The libraries organize families of element types. When the system encounters an optimization problem, software modules identify the requirements of the problem and access the elements libraries to peruse the elements options. Specific elements are assessed, selected and combined into unique configurations in order to solve the problems.

In the case of complex evolutionary optimization problems, specific elements are combined and recombined into multiple configurations until the solutions are effective. This process of accessing elements in libraries allows on-demand real-time utility of efficient software code applications.

While some libraries are general and supply a variety of elements, other libraries are specialized and focus only on specific families with particular applications or classes of problems. In these cases, the libraries may be geographically diverse and require access from different locations. The system accesses these specialized libraries at different locations to pull together solutions to complex problems. The past successful solutions of past problems are recorded and stored in the libraries for future access. In some cases, the past solutions are insufficient to solve a new complex optimization problem, but the data sets are useful in discovering new solutions.

If the access to combinations of elements at specialized libraries fails to solve a problem, the system moves to construct customized element combinations to solve the problems. Once solved, the custom element(s) are registered in the libraries for future reference.

(8) System and Methods for Combining Program Code Blocks and Elements into Software Modules for Self-Assembly

Software modules consist of program code blocks and program code elements. The blocks and elements are self-assembled in multiple configurations in order to solve different optimization problems. Multiple components of program code elements are combined by aggregating elements from different locations. Once one or more code blocks are combined, the software modules seek out the specific code elements necessary to solve the problems.

The system uses a process of experimentation in order to combine specific code elements into a specific configuration to solve optimization problems. The software module configuration is tested by seeking to solve the problems and the system receives feedback. The system then reassesses the effectiveness of the elements, subtracts some elements, adds new elements into a new configuration and retests the new configuration. This process continues until the problem is solved.

In particular, evolutionary problems require automating the self-assembly of code blocks and elements into software modules.

(9) Methods for Activating Program Code Functionality with Code Element Aggregation

Software modules provide utility by activating a specific functional application. The software modules consist of program code blocks and program code elements. The blocks are the core components of the software modules, while the elements provide specific functionality. In effect, the elements operate as a missing link to complete the final components of the software module and therefore activate the program code in an application. Used in this sense, software modules are activated in the context of an application by completion of the module with specific elements. This approach represents a lock and key model of software activation because specific code elements act as a key to initiate execution of a larger code system.

Specific software modules are pieced together to satisfy a threshold or to complete an active mode. In some cases, all modules are needed. For example, a group of completed modules require location specificity to activate a program function.

The aggregation of software module components into a specific combination of blocks and elements to activate an application function or to solve an optimization problem transcend missing or incomplete program components. The system generates criteria for activating specific code components in specific configurations. An adjunct of this approach shows that code blocks and elements are reusable.

### (10) Methods for Reaggregation of Program Code Modules in Hardware

While program modules are organized for specific functionality by aggregating program code blocks and code elements into specific operational configurations, active and interactive applications require the restructuring of the program code component configurations. The present system provides mechanisms to reaggregate program code blocks and elements into novel configurations to solve new and evolving optimization problems. Particularly in evolutionary environments of constant change, it is necessary to establish a system for the reorganization and reaggregation of software components to solve new problems.

As the environment changes, the software system identifies the changes and reacts by reconfiguring the structure of the program code components. Specific program code components, including code blocks and code elements, are disaggregated and then reaggregated into new configurations.

The system uses set theory and combinatorial algebra as a guide for the combination of elements. The system models the software module component configuration options that are required to solve optimization problems. The model uses metaheuristics algorithms to guide the solution generation process. The model guides the software component aggregation and reaggregation processes as they interact with the evolutionary network computing environment.

This process of reaggregation is useful because it allows the modular software system to track, adapt and co-evolve with the changing environment.

### (11) Method for Implementation of Program Code Modules in Hardware

In general, computer and communications hardware systems and components are stationary devices, while software code components are capable of mobility and evolutionary and problem-solving behaviors. In the present system, modular software code embodies architecture in which mobility, evolutionary and problem-solving behaviors are characterized and optimized. However, the software module architecture is compatible with hardware implementation.

Software modules are interoperational in chips and computer nodes within a computer network. The operation within different computer platforms expands operational effectiveness of the modular software system.

Software modules operate within microprocessors, ASICs, 3D chips and on system on a chip (SoC) and network on a chip (NoC) platforms of fixed structure semiconductors. Software modules are fully operational with memory components as well, utilizing various semiconductor configurations.

Further, software modules are used in evolutionary hardware, including FPGAs, CPLDs and hybrid chips. Modular software is well suited for co-evolutionary processes by continuously adapting its configuration as the hardware reconfigures so as to solve complex evolutionary environmental optimization problems.

Software modules are functional in different software operating systems, including versions of UNIX, PC-based systems and open source systems.

Software modules are also fully functional in highly parallel computer systems, including complex computer networks. Software modules are functional in switches and routers of nodes and hubs of computer networks to control system functions.

Modular program code enables continuous interactivity in hardware by executing tasks, solving problems, disaggregating, reaggregating and evolving to complete a function.

### (12) Method for Software Agents to Perform Analysis and Modification of Program Code

Software agents are autonomous program code that performs specific tasks such as analysis, search, organization and problem-solving functions. Software agents are used in the present system to analyze and organize software modules and their components.

Software agents employ analytical techniques, including modeling and metaheuristics algorithms, to solve complex optimization problems. Agents identify missing program code elements in software modules that are required to complete specific functionality. Agents analyze the unique combination of elements required to perform a set of tasks. Agents reverse-engineer solutions to problems and then supply the precise program code block and element combinations required to solve the problems. The system then retrieves and aggregates the components to perform specific functions.

Multi-functional software agents are used to perform multiple tasks simultaneously. For example, multi-functional software agents identify problems, identify solution candidates, assemble the program code blocks and elements into specific configurations to solve the problems, test the solutions, add new elements and regroup the blocks and elements into new configurations to solve problems. As problems evolve, the multi-functional software agents co-evolve processes with program code blocks and elements to solve these problems.

One analogy of the use of software agents in the present system is to the enzyme “dicer” used in every cells' ribosome to convert genes to RNA and to proteins. The agents configure the code blocks and elements into new arrangements by continuously analyzing and resorting the combinations of software module components.

### (II) Modular Program Code for Database Management System

The present system consists of modular program code that facilitates the storage, organization, reorganization and retrieval of data objects in databases. The database type may be an object database, a relational database, an object-relational database or some version of these types. The processes of aggregation and disaggregation of objects are facilitated with modular program code to increase storage and retrieval efficiency, to optimize memory utility and maximize encryption. The system is particularly useful in storing video object components.

### (1) Methods for Storage of Modular Components in an Object Relational Database Management System

Software modules interoperate to store and retrieve objects in databases. Program code components are used to accompany and store object components. These processes occur in different types of databases.

In the simplest example, software modules are used to facilitate the storage and retrieval of whole objects in a simple object database in a fixed location. Since the database represents a large warehouse, the whole objects are stored in specific locations in the database.

Software modules are used to facilitate the storage of object components in different locations of a database. The database type may be an object database, a relational database or an object-relational database. The software modules are used to disaggregate, position and retrieve the object parts at different locations within the database. The object parts are tagged and registered in tables for easy access to different object part locations in the database.

A similar model of object component storage and retrieval is used in distributed databases in which the locations of the databases are spatially differentiated. In these cases, software modules are used to store, organize, reorganize and retrieve object parts across multiple databases.

In a further embodiment of this approach to using software modules to facilitate storage, organization and retrieval of object parts, object parts are circulated within a database or a set of distributed databases, for efficient system management. In this example, the object parts are periodically moved from database location to location to improve efficiency. For instance, the use of active object components is increasingly stored in more easily accessed database locations while less used object components are stored deeper in a database that involves slower retrieval. In these cases, there is a need to constantly update the master table by using software modules to relocate and track the object parts from location to location as the storage locations change. While a master table is centralized, when the table is updated, it is copied and sent to strategic hubs for easy access at different locations. In addition to master tables, the system uses relational tables for automated updates and reference tables in a distributed context. Specialized tables are also used on specific types of chips to access memory components.

Finally, the system applies to transformable database architectures that reconfigure to efficiently accommodate storage of objects and object components. Active database management systems use software modules to constantly recirculate objects and object components.

Once stored in various locations of a database, or databases, software modules are useful in efficiently retrieving the objects and object components. The software modules access tables to identify object component locations.

(2) Methods for Disaggregation and Reaggregation of Objects Stored in Database with Modular Program Code

Software modules are used to break up objects into parts and store the parts in different locations of databases. The software modules first analyze the objects and identify the optimal way to divide the object into discrete components. The software modules then assess the composition of each object component to determine the best ways to store the parts. Each object component is classified by type and sorted by location within the database system. Specific object classes are identified. Video objects, spreadsheet objects, model objects and relational field objects are classified and organized. The software modules then sort the object components into organized categories and register the components in a master table identifying storage location(s). The software modules then store the object components in the specific database location(s). Once the object components are searched, the software modules access the table for the specific component location and retrieve the component parts in a specific order to reassemble the object. This process of decomposition and recomposition of object parts allows the dbms to organize objects in different locations to maximize storage and retrieval efficiency. The least used components are stored in locations that involve slower access, while the most used components are accessed rapidly from specific locations.

The software modules are used to tag the object components and to register the parts into the table. Each object part is given a code to identify the location of the database and the position of the component in the overall object.

By breaking up objects into parts, software modules are able to order and reorder the objects by using and accessing a master key in the tables. The objects are reassembled by the software modules into increasingly efficient forms as specific parts are regularly used and others are rarely used.

Different sorts of objects are stored and managed differently in the dbms using software modules. A graph or table is structured with an emphasis on relational functionality, while a video object is organized with linear functionality. Each object type is classified in different ways by the software modules in each type of database system depending on the trade-offs of each dbms.

Finally, software modules are used to push multiple objects into a distributed database management system with multiple pipeline avenues. In these cases, the automated features of the software modules are used to accelerate the disaggregation and reaggregation processes of multiple object components.

(3) System and Methods for Elastic Queuing of Software Memory for Use with Modular Program Code Components

Software modules are used in processes of software memory management. In software memory management systems, queuing processes are employed to temporarily store program code and data objects. The queue is a limited state, like a temporary waiting period. The most typical queue process is a “first-in first-out” (FIFO) system in which a data component is placed into software memory and discharged in a specific regular order.

In the present system, modular software allows the queue memory system to be elastic. That is, the queue system elongates and restricts the size of the memory in order to accommodate variable data objects. The software modules analyze the object and anticipate the software memory requirements. The software modules then expand or contract the usable software memory in the queue. One way to perform the elastic process is to use multiple pipelines of access for object storage and retrieval. This model of changing the structure of the elastic queue of software memory optimally manages the object life cycle. By allowing the software memory to adapt its structure periodically, the system is able to perform varied tasks in real time with a finite memory.

(4) Method for Object Encryption with Disaggregated Modular Program Code

Data security is becoming an increasingly important part of data management. Modular software is useful for preserving data security.

Software modules disaggregate objects into object components. One of the advantages of this approach is to integrate encryption features into object components to preserve security and data integrity. The software modules encrypt objects and object components before they store the parts into specific database locations. This encryption process is integrated into the reference of the object parts into the master table. The encryption of the object components acts as a filter that requires the master table key for decoding the object component.

Software modules are used to filter viruses and malicious code at specific intervals. The modules are used to encrypt the object components after they are disaggregated. The encryption codes are integrated into each software module. Therefore, the software module is required to decode and reaggregate the object components as they are reassembled into an effective useful object.

When a virus or malicious code is detected by a software module, the affected object component is isolated and either replaced, destroyed or embargoed.

In another embodiment of the system, the disaggregation of objects by software modules alone suffices to keep data safe because without the intact integrated object the object integrity is lost and the data rendered useless.

In the context of a computer network, software agents facilitate the process of data security by operating from within each specific system node. All objects that pass through each node are screened, assessed and filtered by software modules for security.

Software modules are used to automatically back up data to preserve data integrity. If a virus or malicious code is detected, then the backed up code is reactivated for effective operation.

### (5) Methods for Video Object Component Aggregation and Database Organization Using Modular Program Code.

As the next generation of the Web develops, video objects become increasingly ubiquitous. Software modules are used to organize video objects.

First, software modules analyze video files by category of content and structure of object. The software modules record index markers or tags at specific points in the video object. The software modules then build indices to map out video objects and organize markers to delineate specific video components in each index. The software modules then compare objects in the database to similar markers.

The software modules organize the tags listed in each index and sort the video components based on the tag type and aspect. Since each video component is synopsized with the tag, the reorganization of the tags allows each component to be edited at specific intervals.

The processes of organization, sorting and reorganization of video objects that are facilitated by the software modules include the compression and decompression of object components.

The software modules employ a hierarchical organization system to rank the qualities of the object components. In so doing, the software modules categorize and reorder image scenes of the video objects by reassembling the object components. In effect, the software modules are used to automate editing functions.

Similar processes are used for audio files. Multimedia objects, which integrate video and audio components, are analyzed and organized by software modules. Interactive video objects are organized by using software modules that analyze and reorganize the object components in databases with adaptive feedback.

### (III) System for Modular Program Code for Network Computing

Modular program code is ideally suited for network computing environments. Modular software operates within specific nodes and hubs within a network. Components of the software modules are mobile and thus interoperate with multiple computer nodes. While the hardware is stationary, the software is flexible, updatable and multifunctional. The ability to modify the composition of software module components allows computer networks to maximize functionality.

Techniques are described to show how modular software is used in solving allocation problems, operating computer network hubs, automating network bandwidth modulation and controlling multiple parallel routers. Techniques are shown for using modular software to solve routing problems in computer networks. Finally, techniques are shown for continuous circulation of modular software components in a computer network, analogous to the interoperation of antibodies in the human immune system, to solve network computing problems.

### (1) System Layers for Modular Program Code in Distributed Computer Network

The system contains several administrative aspects for constant management control of inter-node communications with software modules. The system layers involve hardware, data storage, software and dynamic behaviors.

On the hardware level, layer one consists of semiconductors. Layer two consists of a node in a computer network and layer three consists of a hub in a computer network. At layer four are distributed hubs in a network.

On the data storage level, layer five consists of data objects. Layer six consists of a single database management system and layer seven consists of a distributed database management system in a computer network.

On the software level, layer eight consists of software modules as basic units of program code. Layer nine consists of program code blocks and layer ten consists of program code elements.

On the level of system dynamics, layer eleven consists of an evolving environment. Layer twelve consists of task feedback from the computer network to the environment. Layer thirteen consists of multi-node plasticity and layer fourteen consists of a reconfiguring of network architecture with evolving software modules.

In the distributed computing environment, objects contain data on their source, present location, destination goal and preferred and optimal pathway(s). Objects are disaggregated and object components are stored in and retrieved from various databases in the network. Software modules are used to organize and encrypt the objects and object components and to control the routers and switches that operate the traffic in the system. The software modules use tags and tables to track the objects in various network locations. Software modules interoperate with a meta-table that is used to preserve updated data for locations of object components and encryption.

(2) System and Methods for Solving Allocation Optimization Problems in Computer Networks with Modular Software

One of the key problems in computer science is the problem of parallelization. The problem involves the need to identify the best way to divide tasks in order to solve the problem efficiently with multiple processors. Parallelization is a distributed computing optimization problem. The modular software system offers an ideal way to solve the problem of parallelization.

The software modules first break down tasks for multiple specialized processors to process the tasks. The processors are classified by type in order to solve specific classes of problems. The processors are located in different locations in the distributed network. The software modules use block and element components in order to divide tasks into specific units for easy “digestion” by specific computing processors. ASICs, FPGAs, microprocessors, SoCs, 3D chips and hybrid chips are allocated specific problems that are suited to specific processors. Computer memory components are optimized by the software modules to run efficiently with the computer processors.

The software module system is used to prioritize and reprioritize the computing processes in a heterogeneous distributed computing environment and, ultimately, derives scheduling protocols for specific tasks. The software modules are also used for routing and rerouting the objects and object components to specific processors in the distributed network with the aim to optimize the efficiency of the system. Finally, software modules are used to modulate elastic bandwidth in the distributed system to optimally accommodate the scheduling and routing processes. This model of using the software module system facilitates ubiquitous computing.

Software modules are used to allocate and reallocate object components to multiple pathways in order to initiate, assess and optimize pathway routing in the distributed network to solve parallelization problems.

(3) System for Operating Computer Network Hub with Modular Program Code

Network computing consists of a distributed system of computers that behave as nodes. Some nodes operate as central hubs connecting clusters of nodes and interconnecting between other hubs. The notion of the hub is critical to understanding the architecture of a distributed computing platform. Hubs consist of hardware computer processors, routers and switches for multi-pathway organization in a distributed system. Software modules are useful in generating and organizing program code and object components in networks.

The hub is a main social structure in computer networks. Multiple pathways are generated from each hub. Nodes are converted to virtual hubs as pathway demand increases to a specific threshold and social behaviors are predominant. In this way, ‘new’ hubs scale up and scale down.

While most hubs operate with pre-programmed program code to manage system operations, the present system uses software modules to generate new program code components to solve network and routing problems as they emerge.

Regarding system security, the present system's use of software modules is beneficial because it uses encryption of specific objects (and components) and filters in each hub to maintain security.

When the present system encounters a problem involving hardware, software or data sets in a network hub, the solution generation process involves employing software agents to analyze, model and solve the problem using software module components. The transition process of configuring solutions after problems have been encountered involves a “burst” of hub activity as the hub control system seeks out and builds solutions using software modules.

In general, software modules are used for network pattern analysis. Modules are used to analyze trends of node use and, by using software agents, the present system uses software modules to model network behaviors, including the anticipation of specific network traffic scenarios.

In an additional embodiment of the present invention, software modules are used to facilitate the auctioning of scarce bandwidth at key hubs at peak times. The modules assess the bandwidth limitations and the demand for bandwidth from multiple applications and allocate scarce bandwidth by creating a schedule for prioritizing bandwidth usage. The modules then organize an auction of specific applications according to priority. This auction model represents an application of combinatorial auctions to network hub bandwidth modulation processes.

Blocks of code and code elements are generated at specific specialized hubs. Specialized hubs are used for specific families of code blocks and elements. The location of block and element families changes periodically as the configuration of hubs change priority in the distributed network.

(4) System for Automating Bandwidth Modulation in Computer Networks with Software Modules

Most distributed computer networks are static. They cannot grow without replacing multiple routers to increase capacity. This constraint restricts system development. By contrast, the present system promotes and facilitates dynamic computer network functionality that modulates growth by modulating the bandwidth available in hubs. By modulating bandwidth, system operational capacity is optimized within the constraints of computational economics.

Software modules are used to modulate bandwidth to and from each node. The modules are used to constantly assess and modulate bandwidth utility efficiency. The modules send test signals to constantly scout and police inter-node pathways. Each node then uses modules to select the best pathway option to send and receive data. By using this approach, the modules are able to assess pathway usage as well as node requirements. The modules are used to “grow” new pipelines between nodes on demand to supplement existing pathways; this process allows the overall system to modulate the pathway capacity. Modules are then used to constantly reroute data traffic in the reconstituted network. This model of elastic and plastic distributed computing allows routers within nodes and hubs to solve evolutionary routing optimization problems by re-equilibrating solutions. By using this approach, software modules operate adaptive super-pathways between adaptive super-hubs as well as self-modulating pathways between adaptive nodes.

From the model of adaptive hubs and nodes, and adaptive pathways between nodes, the software modules are used to schedule data object and object component transportation to optimize the overall system load. As the network configuration itself adapts, the data object transportation process is constantly rescheduled and optimized.

Software modules in nodes and hubs are used to activate reorganization processes at specific thresholds of activity. Thresholds are adjusted for action of different levels of operations.

As activity in nodes increases, the threshold for spiking behaviors is controlled by the software modules. The modules assess, schedule, control and organize the bandwidth modulation of each hub and node. From an equilibrium pulse of activity, the modules are used to control the burst of functional activity in each hub and node as it spikes from an initial equilibrium state to a later equilibrium state.

### (5) System for Modular Code in Multiple Parallel Routers in Computer Network

One model of a distributed network eliminates hubs and uses only nodes as components of communication. This model follows the transition from servers (hubs) to PCs (nodes). In this model, all routing is performed from point to point between nodes rather than between hubs (that then use nodes in a second order configuration). In this case, nodes include routers to route data from node to node. However, in this inter-node distributed model, routers need to have parallel routing capability so as to route simultaneously to multiple nodes. Modular code is ideally suited for this inter-node distributed model.

Modular code is used to sort priorities and to disaggregate and recombine module components (blocks and elements) in decentralized point-to-point nodes. The increased functionality of parallel routers using modular software allows the distributed computer network to use multi-pipeline approaches. In effect, the introduction of multiple parallel routers by using modular code in nodes is similar to multiple runways at an airport; however, rather than be restricted to an airport analogy, the present system uses multiple runways in a house's driveway for node-to-node functionality. By increasing functionality in each node, the costs of routing data diminish as the system increases in simplicity without hub system layers.

The advantage of using software modules in node-to-node parallel routers produces advanced network plasticity because nodes are added and removed over time to accommodate system growth. As nodes are added, new pathways are configured by system routers. Software modules are an optimal system component for the control, organization and management of these elastic networks. As the system adds and subtracts nodes, the system rebalances. Each node is constantly updated with code elements to register new nodes and to remove old nodes.

Software modules are used to analyze patterns of network behavior. By analyzing past patterns of behavior, the system is able to identify anomalies in detail and model solutions.

Modules send data to the closest available node in some cases and to the closest available specialized node in other cases. The location options are constantly resorted by the software modules in the parallel routers in order to maintain maximum efficiency.

In addition to applying software modules to the routers in hubs to control network data flow, software modules are used in intra-node databases. The databases in each node are scalable and extensible and modulate with data flow rate changes. Modules are replaced periodically in each node in order to optimize database configuration and usage. Software modules facilitate the process of circulating specific applications in computer networks between the modulated databases by using the parallel routers in each node. From this use of data in node-to-node computer networks by using the modules, databases and routers described in the present system, multi-tenancy processes in cloud computing operations are optimized. The present system describes new methods to optimize operations of a super cloud.

By using software modules, multiple parallel routers in different nodes are able to communicate with each other, create and suppress direct pathways on demand and create multiple pathways simultaneously to promote intra-node multi-tasking mechanisms.

Taken together, the present invention involves composition of operating system components in a distributed computer network.

### (6) Methods for Routing Modular Program Code in a Computer Network

While modular software is useful in routers, nodes and hubs, it is also useful because it is transportable to other locations. Specific modular code components themselves are routed to different network nodes and computers. The mobility of program code has the advantage that specialized code is transported to specific computers to perform functions rather than regenerating complex code for each new use.

One approach works as specific problems are encountered at a node and the node requests specialized solutions by importing specific program code modules. This is similar to identifying a disease and requesting an effective medicine from another location to solve the problem and restore health. This approach works as code is attracted to a specific node to solve a problem. Further, code blocks and elements are recruited to a specific node from multiple locations. As the software modules solve the node-centric problems, the nodes intensify the process of obtaining more software modules as they need to scale up, and, conversely, slow down the process of using software modules in problem solving.

Another approach pushes program code to specific nodes as updates are automatically dispatched to solve specific problems or to anticipate specific problems.

A third approach uses software modules to organize and reorganize groups of objects and object components to optimize routing in a network. In this approach, travelling salesman problem (TSP) algorithms are applied by software modules to coordinate data object traffic collective behavior. Batches of objects and object components are reorganized at each node for transport to its destination. The software modules are used to identify, separate group, reorganize and reaggregate collectives of data object components in parallel pathways. This process is analogized to individuals and baggage automatically moved through airports to their destinations in the most efficient ways available.

The use of software modules in nodes in the distributed system constructs an active router. In a passive router, pre-programmed code is launched to perform specific functions in a specific prearranged sequence. In an active router, software modules are used to custom configure solutions on demand. The active router effectively transforms the structure of the distributed network itself by reconfiguring each node to modify elastic bandwidth operation in parallel pathways simultaneously in order to adapt to an evolving environment.

### (7) System and Methods for Circulating Program Code Blocks and Code Elements in a Computer Network

Software modules are used in multiple ways in the nodes and hubs of computer networks to promote efficient operation. To maximize efficiency of network operations, the program code components are organized into families in order to effectively apply solutions to functional problems. The code blocks and elements are continuously updatable as they are activated to solve problems.

The software module components are constantly circulated between nodes in a distributed network. The locations of circulating code blocks and elements are tracked by hub (and node) databases.

Program code elements make regular sweeps through the network in order to seek a “fit” in each node to complete tasks. The elements are de-aggregated and re-integrated into different combinations in order to perform new tasks and to solve new problems. The elements are constantly recirculated in order to maximize system efficiency. The advantage of this approach is that the elements are probabilistically closer to key nodes that require their functional utility at key times. In effect, the elements are pushed to specific locations in order to supply the materials for solving problems. In other cases, the nodes are attractors of specialized elements from specific families in order to solve specific classes of problems.

The inspiration for the recirculation of program code elements in a distributed computer network is the human immune system. In this example, antibodies constantly circulate in order to detect antigens and proceed to escalate a set of processes to defeat the invaders.

Similarly, program code elements are able to detect anomalies, anticipate and analyze problems, and model scenarios and build solution options to solve the problems before they escalate. As the problems do escalate, the elements will call for increased software modules to scale up to optimize solutions.

### (IV) System for Modular Program Code Using Metaheuristics

Metaheuristics are learning processes that are integrated into computer systems in order to solve complex optimization problems. Metaheuristics are classified into specific categories of techniques, including swarm intelligence, local search and artificial immune system. Each of these approaches, and their derivatives and hybrids, apply memory to perform functions to solve optimization problems.

Metaheuristics are applied in the present system by integrating program code blocks and elements in software modules for the operation and management of computer systems. The system uses ACO, swarm and local search approaches to solve specific classes of computer optimization problems. Metaheuristics are useful for the coordination and aggregation processes of software module components.

Problem-solving metaheuristics are useful for analyzing optimization problems. The metaheuristic algorithms are broken up into parts and organized with program code blocks and elements by combining and recombining elements into novel configurations within software modules. Each software module is able to represent a specific hybrid metaheuristic custom configured to solve a specific class and type of optimization problem. Finally, since they use reconfigurable code elements, the metaheuristic software modules are adaptive to evolutionary problems.

### (1) ACO Metaheuristic Applied to Modular Code Collective Behaviors

Ant colony optimization (ACO) is a class of swarm intelligence metaheuristic that computationally emulates ant behaviors using pheromones to perform functions such as foraging. Once a problem is identified by a circulating code element in a computer networking environment, software modules containing the ACO metaheuristic algorithm are activated to solve the problem. The ACO metaheuristic algorithm then seeks to solve the problem by bringing other code elements from libraries to analyze and model the problem and provide solution options that are tested and selected until the problem is solved.

By using the ACO metaheuristic algorithm, routine pathways in a network are strengthened. Plasticity behaviors are promoted by increasing use in regular pathways while less used pathways are diminished. Software modules employing the ACO metaheuristic algorithm patrol the network and analyze the usage of specific pathways.

When the software modules identify a problem in a node or hub, the software modules activate a burst of activity to call more program code blocks and elements to perform tasks to solve the problem, escalating the solutions until the problem is solved. The increase in use of software modules is drawn from a specialized hub organized to address and solve a specific class of problems. The system is designed to promote multiple problem-solving programmes simultaneously by using multiple hubs to supply bursts of software module component usage to solve numerous problems. In some cases, multiple hubs supply software modules on demand to solve complex problems at different locations.

Use of the ACO metaheuristic is particularly useful to organize and manage the operations of collectives of program code elements. After the ACO software module is dispatched to identify and analyze a network anomaly, program code elements are requested from a hub library to solve the problem. Until the problem is solved, the ACO software module manages the increased application of code elements from various locations and guides the management of a solution until an effective solution is designed and applied. Once completed, the ACO software module returns to a particular hub until new anomalies emerge.

### (2) Method for Implementing Swarm Intelligence Metaheuristic Using Software Modules

Particle swarm optimization (PSO) is a type of swarm intelligence metaheuristic that uses the collective behavior of decentralized autonomous entities to perform a specific function to solve an optimization problem. The swarm computational algorithm is based generally on the behaviors of bees, bird flocking and fish schooling. Like an enzyme, metaheuristic algorithms are used to shortcut solutions to optimization problems. The PSO algorithm is applicable to network computing problems by using software modules.

Groups of program code elements work together to solve problems. Code elements are grouped in libraries that categorize the elements according to type. The elements are requested by specific nodes to solve specific classes of problems. Software agents are used to retrieve software modules with specific elements. Further, elements are requested to refine solutions until problems are solved. Differentiated elements are collected by software modules from different locations in order to solve a problem at a particular node. The software agents, the software modules and the code elements use PSO algorithms to coordinate the collective behavior of the differentiated components in order to solve the problem. The ability to self-organize program code to solve an optimization problem, or to solve multiple simultaneous optimization problems, facilitates the management of automated programming.

In another embodiment of the invention, the system uses stochastic diffusion search (SDS) metaheuristic algorithms. SDS algorithms use memory from different parts of the distributed network and share the data with members by directly transmitting the data to memory in different locations. This model is useful for point-to-point distributed networks and for organizing collectives of software module components and data object components.

In addition to the PSO and SDS metaheuristics, the system also uses hybrid swarm intelligence metaheuristics.

The use of PSO algorithms to solve network computing optimization problems involves the self-generation of software module components, evolutionary programming, program code element reaggregation processes and self-assembly. The collective coordination of elements to resort and recombine by using PSO illustrates the self-assembly operations of the present system.

(3) Self-Organizing Object Components with Modular Code Cooperation

Objects are broken down into smaller units in the present system for easier storage and security. The object components are self-organized by using software modules that automatically decompose, analyze, store, register and retrieve the components. Modular program code is used to perform these self-organizing object component management operations.

Program code components, including blocks and elements, are used to perform multiple computing operations. The code components coordinate their behavior, and cooperate, by using metaheuristic algorithms. Cooperative software components have specialized functions that work together in a division of labor to solve specific classes of problems.

The cooperating code elements analyze objects, separate object components, encrypt, identify database storage locations, tag and record the data storage locations in tables and store and retrieve the components. The use of cooperating code elements and agents are contrasted with competing code components, which are organized in competing teams with time-sensitive objectives.

### (4) Reaggregation of Code Blocks and Code Elements Using Software Module Collective Behaviors

Software modules are comprised of program code blocks and program code elements. The elements are groups of small sequences of code that perform specific tasks. The aggregation of the elements constitutes a new configuration of software modules that solve different classes of complex problems. The software modules are constantly reorganized by reaggregating the elements. The elements are organized like pieces of an open-ended evolving puzzle. As the problems evolve in a network computing environment, the elements constantly reconfigure to solve them.

The program code elements use swarm metaheuristic algorithms to solve problems. The elements engage in self-organizing collective behaviors that modulate the velocity of aggregation and reaggregation processes to manage different classes of problems. These social and collective behaviors of multiple software modules and code elements represent the backbone of multiple integrated automated network computing operations.

The reaggregation processes of code blocks and elements are performed by modeling the combinations of sets of components in different configurations. While the combination of different blocks and elements is performed to assess optimal aggregation of unique components to solve problems, the system also must identify conflicts between code components so as to prevent incompatibilities between code types.

The use of collective behaviors and reaggregation processes in network computing operations are useful to simultaneously perform multiple parallel tasks.

(5) Plasticity Behaviors in Computer Network with Collectives of Software Modules

Multiple metaheuristics algorithms are used in the present system to manage network computing functions. The combination of metaheuristics algorithms are used to perform self-organizing, adaptive and plasticity operations in a network. In effect, the combination of these processes promotes the view of a super neural network. The methods applied in the present system using software modules transform a distributed computer network into an adaptable circuit.

Unlike a passive computer network, interaction, feedback and experimentation processes using software modules make the present system adaptive and plastic. The system contains evolutionary aspects capable of problem-solving.

### (V) System for Modeling Modular Program Code

In order to analyze system problems and generate system operations to solve the problems, the present system uses modeling resources. Modeling is used to analyze problems and to organize solution options using modular software components. The modeling processes are used to order, aggregate, reaggregate and reconfigure program code components until evolutionary problems are solved.

### (1) System for Analytical Modeling of Software Module Behaviors

Software module components are configured in different arrangements in order to perform specific tasks and solve problems. The code blocks and elements are combined into different configurations by aggregating the software components in different ways. The challenge for the system is to identify ways to model the code block aggregation configuration options in order to perform tasks or to solve problems on demand. The challenge is particularly complex in evolutionary environments which require adaptive solutions and reconfigurable software module components.

One way the system is used to organize models of software module component aggregation is to analyze past network patterns and to assess the solutions used successfully to solve problems. These past patterns and solutions are stored in databases.

During periods of system equilibrium when the network utility is minimal, the system focuses on the analytical aspects of modeling and solving problems rather than on the active aspects of engaging in solution generation and application.

Software agents are used to collect data objects to build models to analyze problems. The agents generate and adjust system parameters in the models to assess problems. The agents generate model scenarios based on probabilities. The agents employ software modules to add features to the modeling process. Once the problems are analyzed and scenarios are generated, the agents are used to generate solution options in the model. The solution options are then compared to a criterion for solution selection and the best available solution option is selected and applied to a problem.

Once a solution option is applied, the system develops a schedule of plans to achieve a set of objectives.

### (2) System for Dynamic Modeling of Software Module Collective Behaviors

Developing analytical models are useful for solving fixed problems. However, complex evolutionary problems, such as those that involve changing and indeterminate variables or environments, require advanced modeling processes. The present system describes methods for the dynamic modeling of solutions to evolutionary problems.

The dynamic modeling processes involve analysis, scenario generation and solution option generation as well as interactive feedback processes. The advanced modeling process uses multiple metaheuristics to identify, analyze and solve complex problems. The software module components are ordered and reconfigured into different combinations by the modeling system. Software agents collect and analyze data for input into the model. The model is used to test different configurations of code blocks and elements to solve problems or to perform tasks.

Since it is dynamic, the advanced model uses interaction between the software module components collective behavior as they self-assemble and the evolving network computing environment. As network computing problems are solved at specific nodes, new problems emerge that require analysis, modeling and feedback interaction until new solutions are generated, and so on. The process of dynamic modeling involves the continual addition to and removal from software modules of code components (blocks and elements). The dynamic modeling system constantly matches evolutionary solutions to evolutionary problems.

(3) Methods for Modeling Modular Software Component Behaviors to Solve Optimization Problems with Local Search Metaheuristics

Local search metaheuristics, developed by Glover, include tabu search (TS) and scatter search (SS) metaheuristics. These local search metaheuristics are optimized to increase efficiency by removing from the remaining search process areas of the domain already searched. The search process involves the storage of past search space in memory, which is useful to prevent a repeat of search space already searched. One inspiration for this computational algorithm is to analogize the process of searching for a lost hiker. Given resource constraints, searchers engage in a search pattern and simply record the areas that they have already searched so as to save time in not inefficiently going over the same terrain again and again.

In the context of the present system, local search metaheuristics (such as TS) are used to eliminate specific program code blocks and elements not to use because they are incompatible, useless or present a conflict with other code. By eliminating specific code components from a prospective solution, the system increases the efficiency of solution generation processes.

As the modeling system experiments with generating specific solutions, and as the solutions are tested and solution options eliminated, these ineffective solution options are stored in a database. The database is accessed by the model as it builds the model solution options so as to eliminate specific code component solution options and combinations from the list of possible solutions. In effect, the system uses the local search metaheuristics to eliminate the least probable solution options. The system prunes the least likely options for completion of a set of software module components into a specific configuration that will solve a problem.

Similarly, the SS metaheuristic is used to identify missing code components that are required to complete a field. In effect, the modeling system uses the local search metaheuristic to complete a picture over time. Rather than eliminate an ineffective component, the system is used to model a correct solution from incomplete information. This same approach is useful to solve problems involving incomplete object components. These applications are useful in cases of resource constraints so as to maximize efficiency.

In another embodiment of the invention, the system uses adaptive memory programming (AMP) metaheuristics algorithms. The system uses AMP to constantly update program code block and element memory and share memory between software module components in real time to produce updated and efficient models. In addition, the system uses hybrid local search metaheuristics for different modeling operations.

The effect of these main approaches to model building applied to software module components is that the system is able to use limited memory to maximize efficiency of problem solving.

### (4) Active Modeling of Interactions Between Software Module Behaviors and Network Computing Architecture Configurations

Once a model is generated to analyze and solve a problem, the software modules are actively applied to test the model. The network computing environment requires the model to be tested and feedback from the solution option test is recorded. An experimentation process occurs between the model solution option and the module solution's effectiveness at solving the problem. In effect, the system embodies a process for rapid prototyping. These processes. are useful in both static network computing environments and in evolutionary network environments.

In evolutionary network computing environments, the problems themselves evolve, thereby requiring evolutional), solutions. Evolutionary problems in particular require interactive module testing processes in order to effectively solve the problems.

The system uses distributed modeling in order to solve complex problems. The system divides problems into smaller problems in order to accelerate problem solving. In this case, multiple specialized problems in the distributed network are solved by modeling the problems in multiple nodes with software modules.

In some cases, evolutionary hardware is used in specific nodes to accelerate the problem solving and task completion processes. FPGAs, CPLDs, SoCs and hybrid chips are used to reconfigure their hardware components in order to complete rapid prototyping processes. The network configurations that modulate pathway generation are restructured by organizing the software modules to accommodate the plasticity of the system. These dynamic processes are furthered by the dynamic modeling processes.

### (5) Computer Network Architecture Plasticity Triggered by Modeling

The system is used to analyze and model the efficient use of software modules in computing networks. Once the model generates, selects and tests solution options, the feedback obtained from the testing process provides data to refine the model and the solution applications.

The model is used proactively to generate predictions of network computing behaviors. The predictions are based in part on probabilities analysis by the modeling system. By projecting anticipations of network behaviors from analysis of past behaviors, the system uses software modules to prevent problems from occurring. The system identifies thresholds of behaviors that are used to activate software modules to perform a task.

By using an active and dynamic modeling process, the system “pre-reacts” based on model predictions. Once specific behavior thresholds are identified and activated, the model stimulates a process of co-evolution of the computer network with the environment. The thresholds are modified so that the system does not over- or under-react. This approach is borrowed from the fine-tuning of the human immune system.

In addition to anticipation of network behaviors, the system anticipates environmental changes. The environmental changes are used to predict network behaviors. The dynamics of multiple environmental, network, modeling and software module behaviors are involved in the complex plasticity processes of the system. The anticipation of environmental events is made by the modeling system within probabilities. Once a threshold of events is achieved, the network activates a reconfiguration based on the model predictions by using the software modules. The plasticity processes are continuous.

Reference to the remaining portions of the specification, including the drawings and claims, will realize other features and advantages of the present invention. Further features and advantages of the present invention, as well as the structure and operation of various embodiments of the present invention, are described in detail below with respect to accompanying drawings.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference for all purposes in their entirety.

### LIST OF ACRONYMS

ACO, ant colony optimization
AMP, adaptive memory programming
ASIC, application specific integrated circuit
CPLD, complex programmable logic device
FPGA, field programmable gate array
NoC, network on a chip
QoS, quality of service
PSO, particle swarm optimization
RNA, ribonucleic acid
SDS, stochastic diffusion search
SoC, system on a chip
SS, scatter search
TS, tabu search
XML, extensible markup language

### DESCRIPTION OF THE DRAWINGS

FIG. 1 is a table depicting system layers.

FIG. 2 is schematic drawing showing a code core and code elements.

FIG. 3 is a schematic drawing showing two phases of change of code elements in a software program module.

FIG. 4 is a schematic drawing of program code core and elements attached.

FIG. 5 is a schematic drawing of a program code module and code elements that solve environmental problems.

FIG. 6 is a schematic drawing of a software program module with additional code elements attached to the core assembly.

FIG. 7 is a schematic drawing of a two phase process of combining code modules and elements into a complex program code module.

FIG. 8 is a schematic drawing of a program code element attached to a software code module that solves a problem by activating an environmental solution.

FIG. 9 is a schematic drawing of families of code elements, with versions that combine to form a software module.

FIG. 10 is a schematic drawing showing a custom block of elements comprised of different families of code elements that solve an environmental problem.

FIG. 11 is a schematic drawing showing replacement versions of program code elements aggregated in program code modules to solve a problem.

FIG. 12 is a schematic drawing showing the combination of multiple program code elements to solve an environmental problem with feedback.

FIG. 13 is a schematic drawing showing a blank space in a program code block sequence for a code element to complete an effective solution.

FIG. 14 is a schematic drawing showing a mix of code elements from different program code languages.

FIG. 15 is a schematic drawing showing an evolving program code block with custom elements needed to solve a problem with environmental feedback.

FIG. 16 is a schematic drawing showing the evolution of a code block with blank space, updated element versions, new elements and out-of-sequence elements to solve problems.

FIG. 17 is a schematic drawing showing the use of modeling, with access to a database, of a solution to program code module consisting of multiple versions of code elements to solve a problem by reverse engineering a solution.

FIG. 18 is a schematic drawing showing the construction of a custom program code module solution, consisting of different versions of program code elements, to an evolutionary problem with environmental feedback by accessing a database.

FIG. 19 is a schematic drawing showing a complex data object that evolves, that has junk object components removed and that is modified by evolving program code module elements.

FIG. 20 is a schematic drawing showing code blocks filtering object components.

FIG. 21 is a schematic drawing showing code elements filter out-of-order object components in a sequence.

FIG. 22 is a schematic drawing showing the conflict between “D” and “R” elements resolved by comparing to a code library and the process of supplementing code elements.

FIG. 23 is a schematic drawing showing the code element library and the process of combining elements from the code library to solve a problem.

FIG. 24 is a flow chart describing use of a database to solve an optimization problem with code blocks and elements.

FIG. 25 is a schematic drawing showing the combination of code element sequences into a code module to apply to a software application.

FIG. 26 is a schematic drawing showing an inactive code module with empty locations that are required to fill like a key in a lock to activate the code to apply to a software application.

FIG. 27 is a schematic drawing showing the evolution of a solution using code elements with feedback from the environment and the storage of an effective solution in a database.

FIG. 28 is a schematic drawing showing the process of using a software agent to build solutions of code modules from a library to test with an evolutionary environment.

FIG. 29 is a schematic drawing showing the evolutionary process of code elements used to solve a problem by accessing the program code library.

FIG. 30 is a schematic drawing showing the program code modules interaction with objects as they evolve and store each module version in a database.

FIG. 31 is a schematic drawing showing the evolution of an object as a software module tags, registers and stores the data in database tables.

FIG. 32 is a schematic drawing showing the process of using a software module for filtering, tagging and registering evolving objects in a database for a specific software application.

FIG. 33 is a schematic drawing showing the process of storing objects in a database by using a software module and applying data to software applications using a software module.

FIG. 34 is a flow chart describing the process of using software modules to analyze and classify objects and store objects in a database.

FIG. 35 is a schematic drawing showing the process of using a software module to tag and register object components in a database table.

FIG. 36 is a schematic drawing showing a software module reorder object components.

FIG. 37 is a schematic drawing showing the software module sorting objects into an elastic queue and storing the objects in a database.

FIG. 38 is a flow chart describing the process of using software modules to modify the software memory of an application to organize objects.

FIG. 39 is a schematic drawing' showing the process of using software modules to encrypt and access objects and object components before they are stored in a database.

FIG. 40 is a flow chart describing the process of using' software modules to encrypt, decode and reaggregate object components.

FIG. 41 is a flow chart describing the process of using software modules to analyze, sort, categorize and reorder video object components.

FIG. 42 is a schematic drawing showing the process of using a software module to decompose an object into components and store the object components in a table and database.

FIG. 43 is a schematic drawing showing the process of using a software module to divide objects into components and filter and route the components to integrated circuits at different locations.

FIG. 44 is a flow chart showing the process of using software modules to facilitate the process of auctioning bandwidth in network hubs at peak times.

FIG. 45 is a schematic drawing showing the use of software modules to process data objects in network hubs and routers.

FIG. 46 is a flow chart showing the process of using software modules to manage computer network operations.

FIG. 47 is a schematic drawing showing the rerouting of nodes during three phases using software modules.

FIG. 48 is a flow chart describing the process of using software modules to manage network components.

FIG. 49 is a flow chart describing the process of applying software modules to databases in a computer network.

FIG. 50 is a schematic drawing showing the process of attracting modules to a problem node to move an object from one node to another node.

FIG. 51 is a flow chart describing the process of solving a network node problem using software modules.

FIG. 52 is a schematic drawing showing the process of moving modules in parallel network nodes.

FIG. 53 is a flow chart describing the process of combining program code elements to solve problems in a computer network.

FIG. 54 is a flow chart showing the process of applying the ACO algorithm to software modules to solve a network computing problem.

FIG. 55 is a flow chart showing the process of using specialized software modules to solve a network computing problem using the ACO algorithm.

FIG. 56 is a flow chart showing the process of using software modules that apply the ACO algorithm to analyze and solve a network computing problem.

FIG. 57 is a schematic diagram describing the use of a software agent to move code from software libraries to network nodes.

FIG. 58 is a flow chart showing the process of using program code elements and software agents to apply the PSO algorithm to solve network computing problems.

FIG. 59 is a flow chart showing the process of applying swarm algorithms to self-organize code elements to solve network computing problems.

FIG. 60 is a flow chart showing the process of using code modules to solve a network computing problem.

FIG. 61 is a flow chart showing the process of using software agents to build models using software modules to solve a network computing problem.

FIG. 62 is a flow chart showing the process of using software agents to facilitate the self-assembly of code modules to solve an evolutionary problem in a computer network.

FIG. 63 is a flow chart showing the process of applying a local search metaheuristic to software module components to solve a network computing problem.

FIG. 64 is a flow chart showing the process of applying the TS algorithm to software modules to solve a network computing problem.

FIG. 65 is a flow chart showing the process of applying the SS algorithm to software modules to solve a network computing problem.

FIG. 66 is a flow chart showing the process of using software modules to solve a co-evolutionary network computing problem.

### DETAILED DESCRIPTION OF THE DRAWINGS

The modular software system interoperates (a) in an integrated circuit, (b) an electronic computer with data storage and (c) a network computing environment. The networking environment enables the multidimensional view of the present modular software system into four main levels and fourteen distinct system layers. The four main levels involve hardware, storage, software and system dynamics.

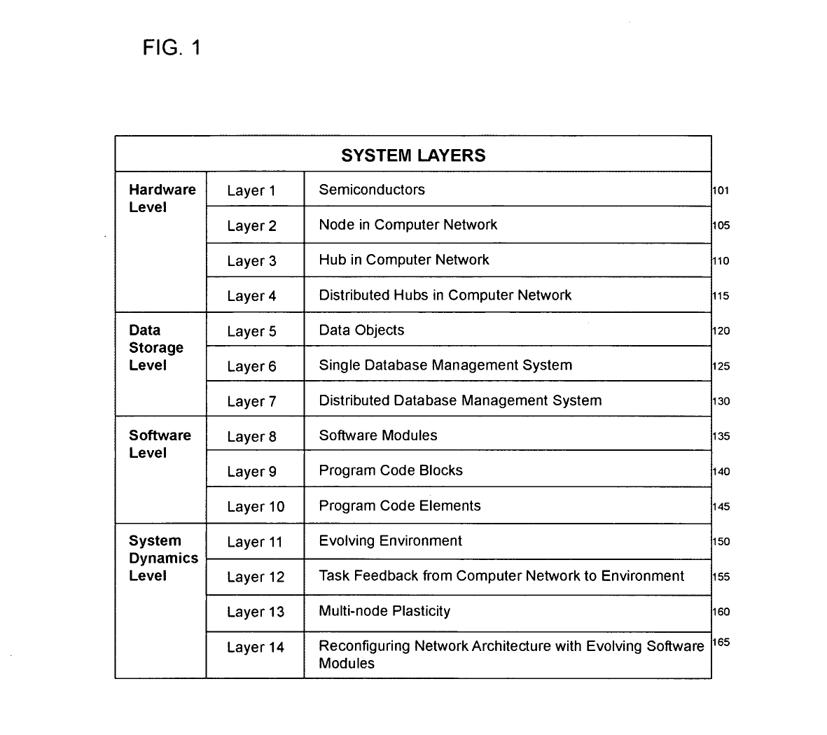

FIG. 1 shows fourteen modular software system layers. On the hardware level, there are four layers. These layers consist of semiconductors on layer one (101), a node in the computer network at layer two (105), a hub in a computer network (110) and distributed hubs in the computer network (115).

On the data storage level, there are three layers. These layers consist of data objects on layer five (120), a single database management system on layer six (125) and the distributed database management system on layer seven (130). On the software level, there are three layers. Software modules are on layer eight (135), program code blocks are on layer nine (140) and program code elements are on layer ten (145).

On the system dynamics level, there are four layers. The evolving environment is on layer eleven (150), task feedback from the computer network to the environment is on layer twelve (155), multi-node plasticity is only layer thirteen (160) and the reconfiguring network architecture with evolving software modules is on layer fourteen (165).

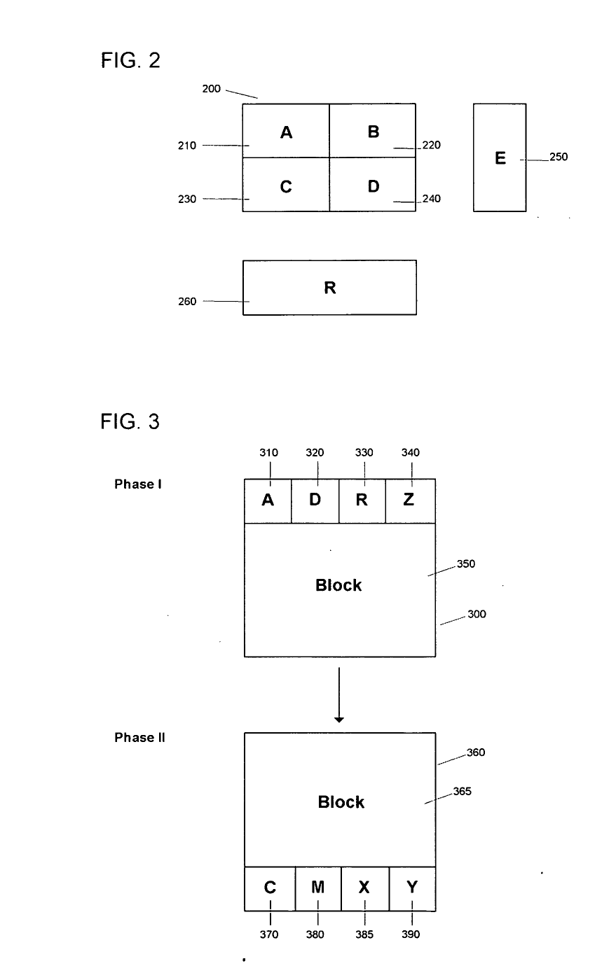

FIG. 2 shows a program code block (200) connecting A (210), B (220), C (230) and D (240) in contiguous sequence. Program code elements E (250) and R (260) are shown separately. The elements may be connected to the block to provide specific functionality.

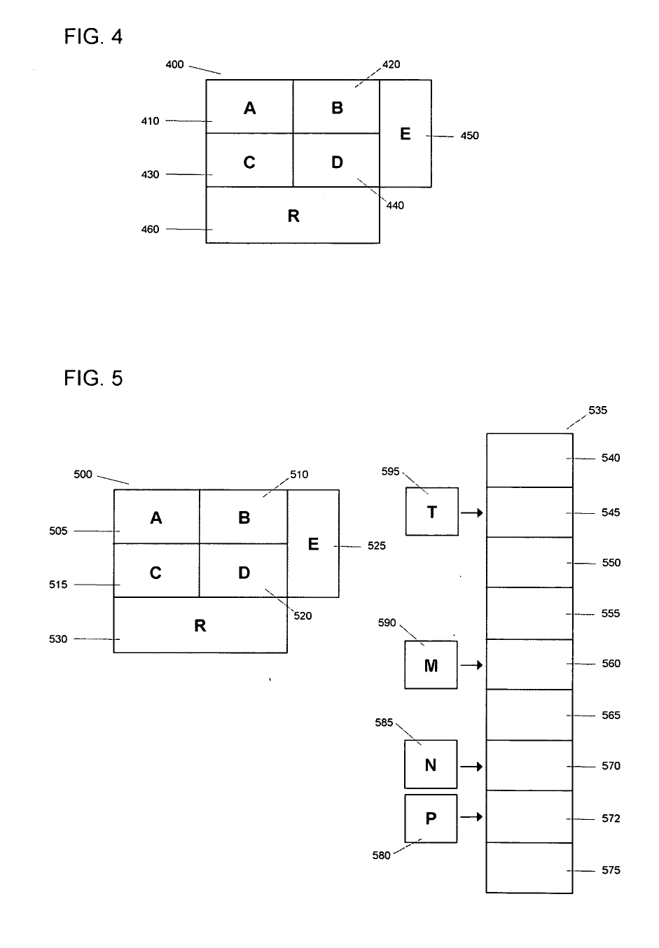

FIG. 3 shows two phases of the evolution of a software module. In phase one,.the module (300) consists of a program code block (350) and code elements A (310), D (320), R (330) and Z (340). In phase II, the module (360) consists of a program code block (365) and code elements C (370), M (380), X (385) and Y (390). In FIG. 4, code elements A (410), B (420), C (430), D (440), E (450) and R (460) are combined into a software module (400).

FIG. 5 shows a software module (500) consisting of program code elements A (505), B (510), C (515), D (520), E (525) and R (530) that interact with code elements T (595), M (590), N (585) and P (580). The code elements T, M, N and P interact with specific applications (535) that refer to environmental problems at 540-575. T interacts with the environment at 545, M at 560, N at 570 and P at 572.

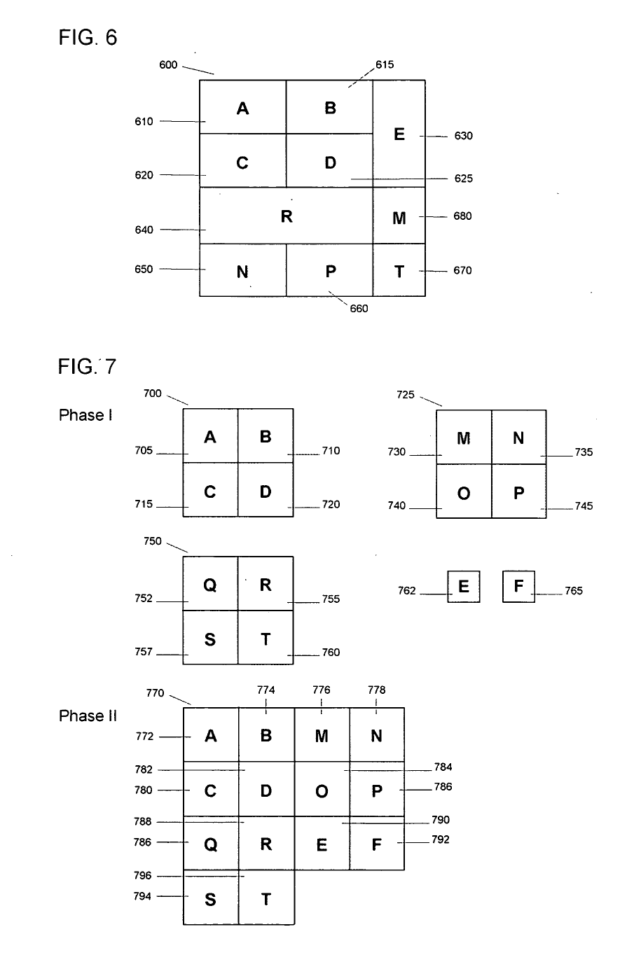

FIG. 6 shows a software module (600), consisting of elements A (610), B (615), C (620), D (625), E (630), R (640), M (680), N (650), P (660) and T (670). Program code elements M, N, P and T supplement the module shown in FIGS. 4 and 5 so as to increase functionality.

FIG. 7 shows program code modules combining in two phases. In the first phase, software modules at 700 (consisting of code elements A (705), B (710), C (715) and D (720)), 725 (consisting of code elements M (730), N (725), 0 (740) and P (745)) and 750 (consisting of code elements Q (752), R (755), S (757) and T (760)) and elements E (762) and F (765) combine in phases II to form a software module (770) consisting of A (772), B (774), M (776), N (778), C (780), D (782), O (784), P (786), Q (786), R (788), E (790), F (792), S (794) and T (796).

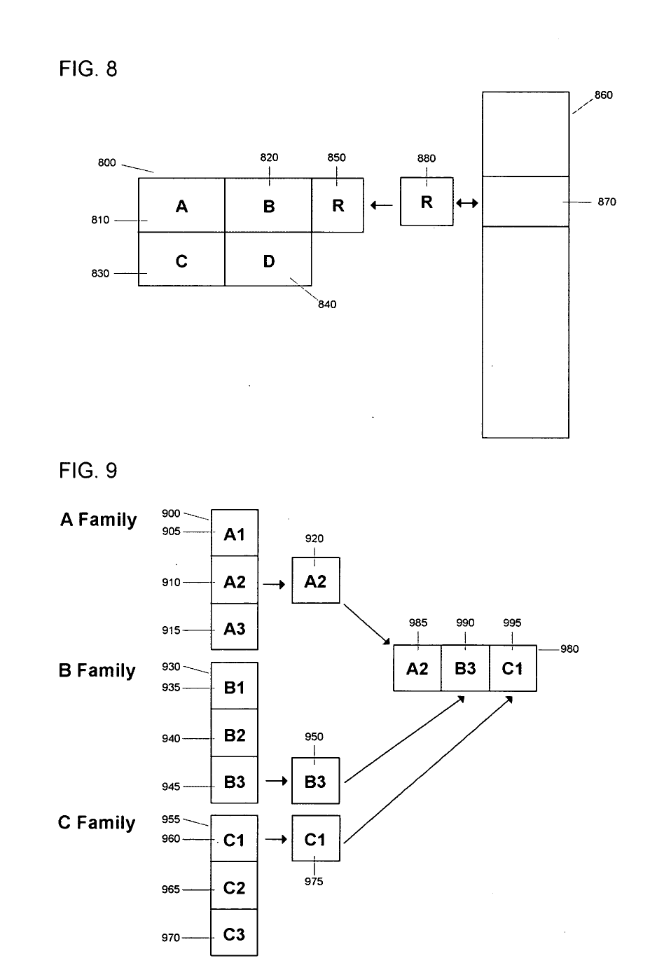

FIG. 8 shows a software module (800) consisting of program code elements A (810), B (820), C (830), D (840) and R (850) in which R (also shown at 880) solves an environmental (860) problem at 870.

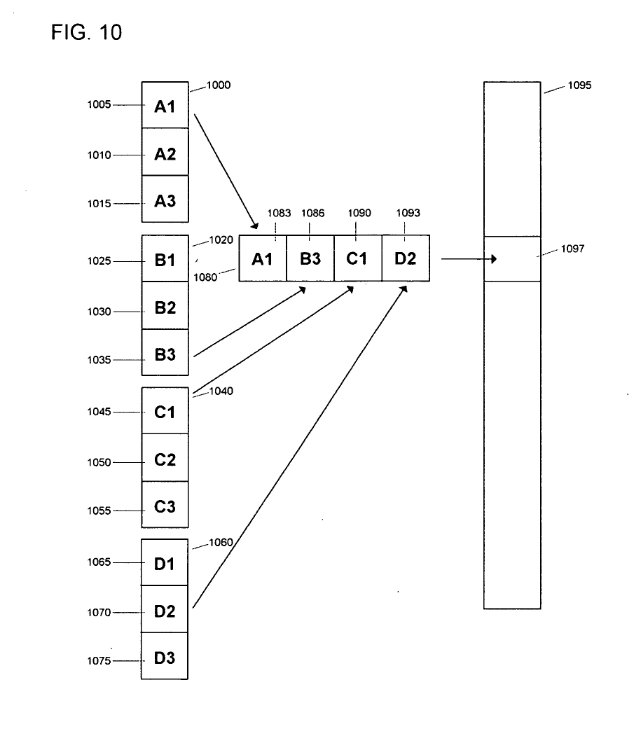

FIG. 9 shows three families of program code elements, A (900), B (930) and C (955). The families consist of A1 (905), A2 (910) and A3 (915) for A; B1 (935), B2 (940) and B3 (945) for B and; Cl (960), C2 (965) and C3 (970) for C. In the example illustrated in FIG. 9, A2 (920), B3 (950) and C1 (975) are combined into the software module (980). In FIG. 10, code element families A (1000) (A1 (1005, A2 (1010) and A3 (1015)), B (1020) (B1 (1025), B2 (1030) and B3 (1035)), C (1040) (C1 (1045), C2 (1050) and C3 (1055)) and D (1060) (D1 (1065), D2 (1070) and D3 (1075)) are used to draw elements A1 (1083), B3 (1086), C1 (1090) and D2 (1093) into a software module (1080), which is applied to solve a problem at 1097 in the environment at 1095.

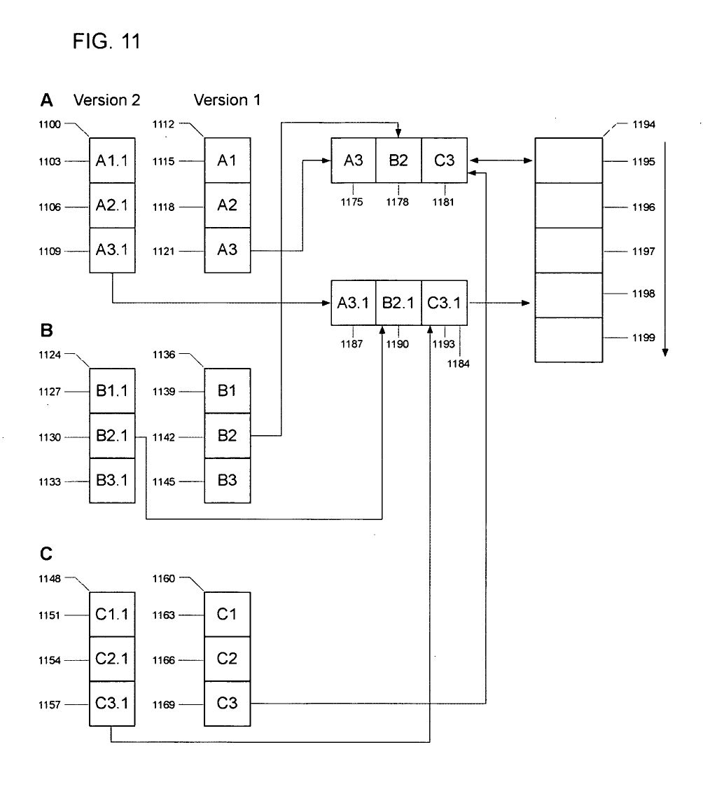

FIG. 11 shows multiple versions of the code element families. In the first version of the software module (1172), which consists of code elements A3 (1175), B2 (1178) and C3 (1181), drawn from the version 1 of family A (1112) consisting of A1 (1115), A2 (1118) and A3 (1121), family B (1136) consisting of B1 (1139), B2 (1142) and B3 (1145) and family C (1160) consisting of C1 (1163), C2 (1166) and C3 (1169). The first software module (1172) is applied to the environment (1194) to solve a problem at 1195 and the module receives and analyzes the feedback. The module then evolves by requesting later versions of the code elements from evolved element families at phase II. In this evolved software module (1184) consisting of A3.1 (1187), B2.1 (1190) and C3.1 (1193), the code elements are drawn from version 2 of each element family, specifically, version 2 family A (1100) (A1.1 (1103), A2.1 (1106) and A3.1 (1109), version 2 family B (1124) (B1.1 (1127), B2.1 (1130) and B3.1 (1133) and version 2 family C (1148) (C1.1 (1151), C2.1 (1154) and C3.1 (1157). The evolved software module (1184) is then applied to a later evolution of the environmental problem (1197) as the environment evolves sequentially from 1195 to 1199. While there are three families, three examples of each family and two versions of each family, the present invention is not limited to a set number of versions, families or sizes of families of code elements.

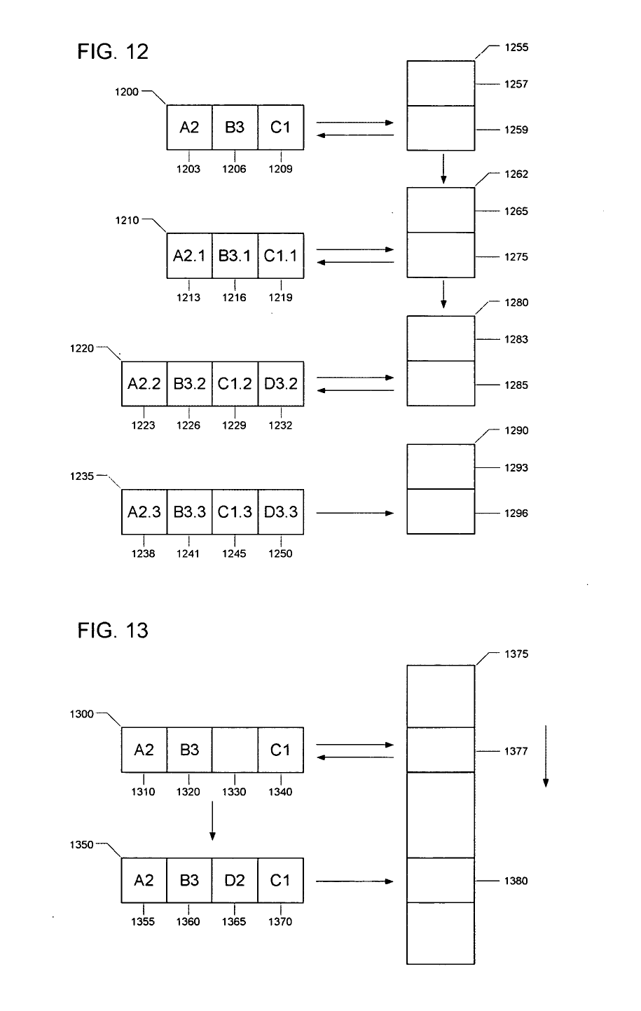

FIG. 12 shows the combination of multiple program code elements to solve an environmental problem with feedback. In the first phase, the module (1200) consists of elements A2 (1203), B3 (1206) and C1 (1209). The module interacts with the environment (1255) (consisting of 1257 and 1259) at phase 1259. The module then evolves after receiving feedback and modifies the elements in the module (1210) to a later version A2.1 (1213), B3.1 (1216) and C1.1 (1219). The module interacts with the environment (1262) (consisting of 1265 and 1275) at phase 1275) and adapts further. The new module (1220) at phase three consists of elements A2.2 (1223), B3.2 (1226), C1.2 (1229) and D3.2 (1232), which interacts with the environment (1280) (consisting of 1283 and 1285) at 1285. The last phase of the module (1235) further evolves and refines A2.3 (1238), B3.3 (1241), C1.3 (1245) and D3.3 (1250) and interacts with the environment (1290) (consisting of 1293 and 1296) at 1296. In this example, the evolution and refinement of the software module from 1200 to 1235 solves the problem.

FIG. 13 shows a blank space in a program code block sequence for a code element to complete an effective solution. In the first stage, the software module (1300), consisting of A2 (1310), B3 (1320), a blank space (1330) and C1 (1340) interacts with the environment (1375) at phase 1377. With feedback from the interaction, the software module evolves to include a code element D2 (1365) that fits in the empty space of the previous version of the module. The new module (13500 consists of elements A2 (1355), B3 (1360), D2 (1365) and Cl (1370). The later version of the module is then applied to the environment at phase 1380.

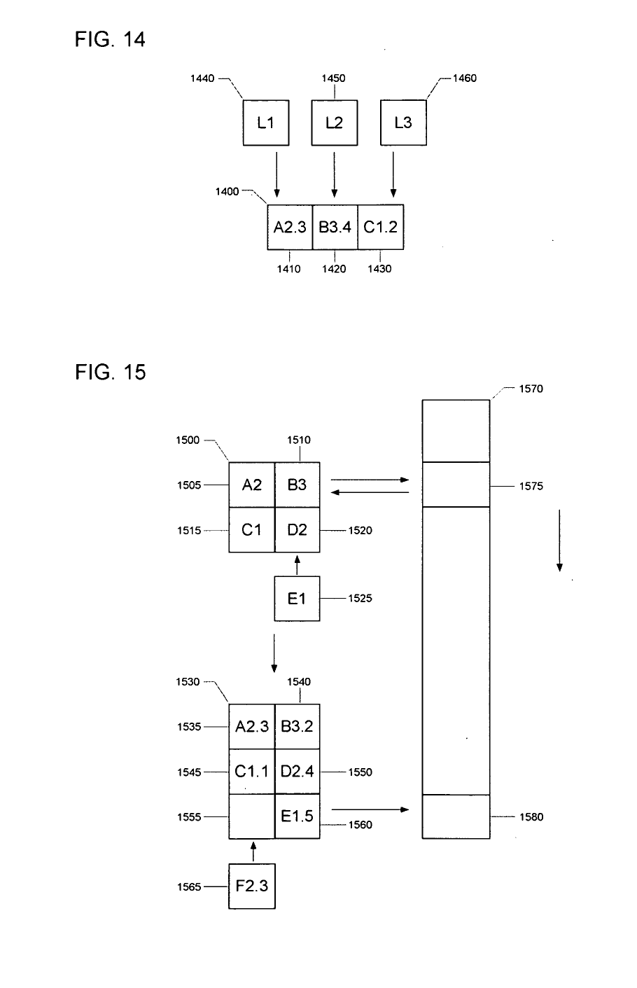

In FIG. 14, the use of different programming languages L1 (1440), L2 (1450) and L3 (1460) are shown producing specific code elements. L1 produces element A2.3 (1410), L2 produces B3.4 (1420) and L3 produces C1.2 (1430) to comprise the software module (1400). Different language elements are inter-operable with translation intermediation code.

FIG. 15 shows an evolving program code block with custom elements needed to solve a problem with environmental feedback. In this illustration, the software module (1500) consisting of code elements A2 (1505), B3 (1510), C1 (1515) and D2 (1520) is supplemented by element E1 (1525) in order to solve a problem in the environment (1570) at 1575. After receiving feedback from this interaction of applying the software module, the module adapts to solve the problem. Elements A-E evolve to include updated versions and element F is added. The new module (1530), consisting of A2.3 (1535), B3.2 (1540), C1.1 (1545), D2.4 (1550) and E1.5 (1560) and blank space that is supplemented by F2.3 (1565) is applied at 1580.

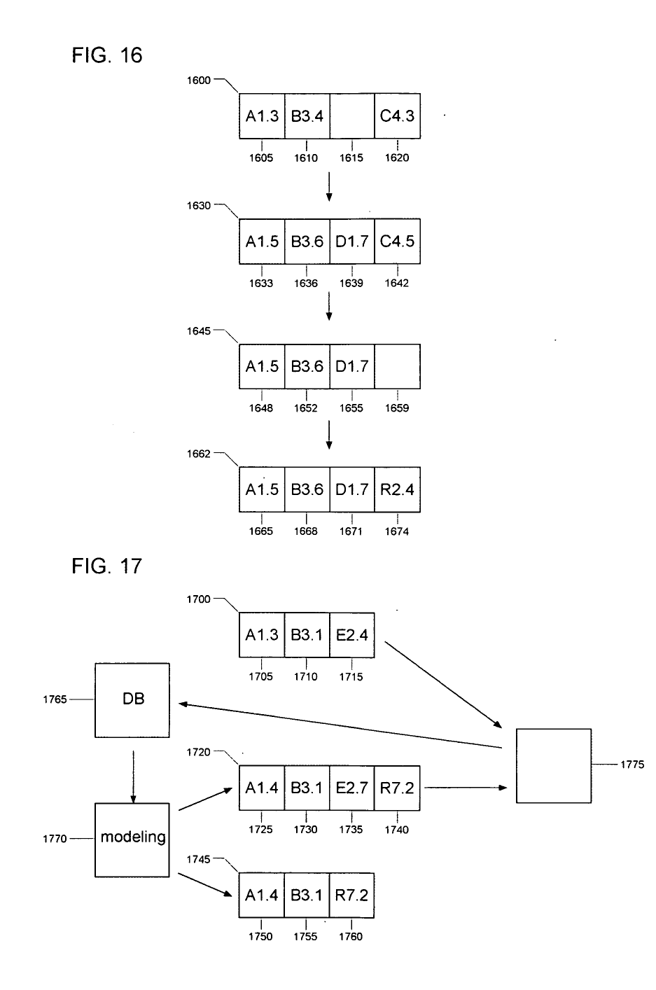

FIG. 16 shows the evolution of a code block with blank space, updated element versions, new elements and out-of-sequence elements used to solve problems. The first version of the module (1600) consists of elements A1.3 (1605), B3.4 (1610), C4.3 (1620) and a blank space (1615). The second version of the module (1630) consists of elements A1.5 (1633), B3.6 (1636), D1.7 (1639) and C4.5 (1642). In the third version of the module (1645), the elements are A1.5 (1648), B3.6 (1652), D1.7 (1655) and a blank space (1659). In the final version of the module (1662), the elements consist of A1.5 (1665), B3.6 (1668), D1.7 (1671) and R2.4 (1662). The evolution of the module from the first version to the second version consists of refining the versions of elements A, B and C and adding element D. In the third version, the C element is omitted. In the final version, element R is added to the elements as they exist from version two. The completed software module solves a specific problem.

FIG. 17 shows the use of modeling, with access to a database, of a solution to a program code module consisting of multiple versions of code elements to solve a problem by reverse engineering a solution. The initial software module (1700), consisting of code elements A1.3 (1705), B3.1 (1710) and E2.4 (1715), interacts with the environment at 1775. The result of the interaction is stored in a database (1765), which then supplies data for the modeling and analysis of solutions. Two new software modules (1720 and 1745) are proposed. The first module consists of elements A1.4 (1725), B3.1 (1730), E2.7 (1735) and R7.2 (1740). The second module consists of elements A1.4 (1750), B3.1 (1755) and R7.2 (1760). Both modules are derivatives of the original module. The first updated module is applied to the problem at 1775.

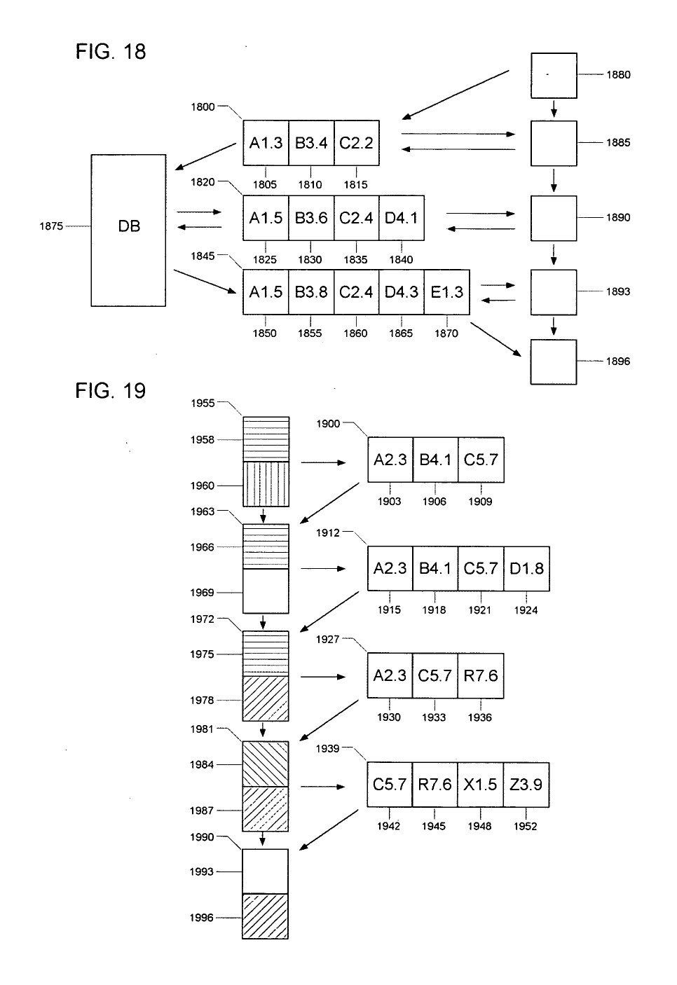

FIG. 18 shows the construction of a custom program code module solution, consisting of different versions of program code elements, to an evolutionary problem with environmental feedback by accessing a database. In the first phase, the software module (1800) consists of code elements A1.3 (1805), B3.4 (1810) and C2.2 (1815) and is created as a result of receiving feedback from the evolving environment at 1880. The initial software module is applied to the environmental problem at 1885, receives feedback and stores the results of the feedback in a database (1875). The system creates a new software module (1820) from information in the database; this module consists of code elements A1.5 (1825), B3.6 (1830), C2.4 (1835) and D4.1 (1840). This module is then applied to the evolutionary problem at 1890, receives feedback and is stored in the database (1875). In the third software module (1845), elements A1.5 (1850), B3.8 (1855), C2.4 (1860), D4.3 (1865) and E1.3 (1870) are shown in combination to solve the problem at 1893, receive feedback and continue to solve the problem at 1896.

In FIG. 19, the illustration shows a complex data object that evolves, has junk object components removed and is modified by evolving program code elements. In the first phase, the system generates a software module (1900), consisting of elements A2.3 (1903), B4.1 (1906) and C5.7 (1909) after encountering a data object (1955), consisting of object components 1958 and 1960. The software module is applied to the new version of the object (1963), which changes configuration to components 1966 and 1969. In this new phase, the software module evolves to add an additional element D1.8 (1912) so that the next version of software module (1912) now consists of A2.3 (1915), B4.1 (1918), C5.7 (1921) and D1.8 (1912). This version of the module is applied to the object (1972), which changes the composition of the components (1975 and 1978). This object version initiates a change of the module (1927), which now consists of A2.3 (1930), C5.7 (1933) and R7.6 (1936). The module is now applied to the next version of the object (1981) consisting of modified object components (1984 and 1987). Finally, this object configuration stimulates the adaptation of the software module's last version (1939), consisting of C5.7 (1942), R7.6 (1945), X1.5 (1948) and Z3.9 (1952), which is applied to the modified object (1990) to interact with its components (1993 and 1996).

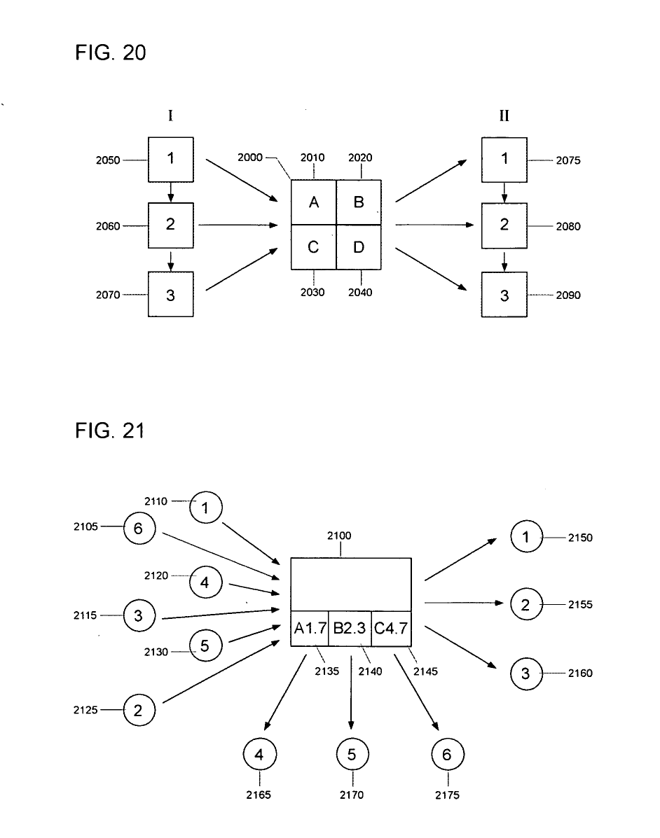

FIG. 20 shows code blocks filtering object components. The program code module (2000) consisting of A (2010), B (2020), C (2030) and D (2040), receives inputs of the object in three phases (2050, 2060 and 2070). The software module (2000) then filters the data object in phase two in three parts (2075, 2080 and 2090). In FIG. 21, the code elements are shown filtering out-of-order object components in a sequence. The objects 1 (2110), 6 (2105), 4 (2120), 3 (2115), 2 (2125) and 5 (2130) are filtered by the software module (2100) that includes code elements A1.7 (2135), B2.3 (2140) and C4.7 (2145) into a numerical sequence of 1 (2150), 2 (2155), 3 (2160), 4 (2165), 5 (2170) and 6 (2175).

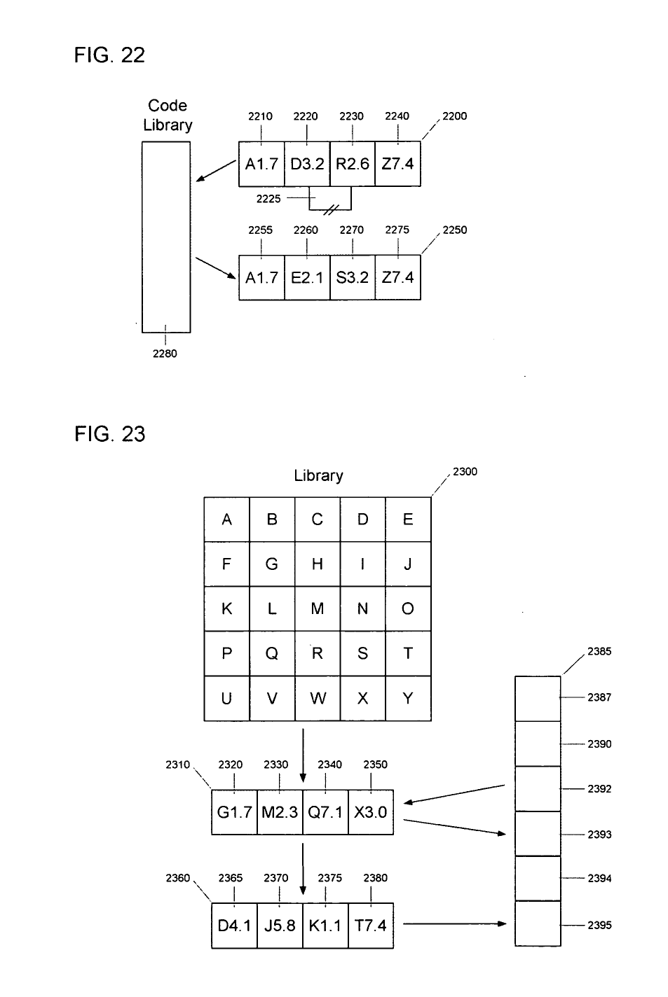

FIG. 22 shows the conflict between “D” and “R” elements resolved by comparing to a code library and the process of supplementing code elements. In the first phase, the software module (2200) consisting of elements A1.7 (2210), D3.2 (2220), R2.6 (2230) and Z7.4 (2240) has conflict between the D and R elements at 2225. The module then accesses the code library 2280) and receives new code elements that remove the conflict. The new module (2250) consists of elements A1.7 (2255), E2.1 (2260), S3.2 (2270) and Z7.4 (2275). The new module may be used to solve problems in the system since the conflicts have been removed.

FIG. 23 shows the code element library and the process of combining elements from the code library to solve a problem. The library (2300) consists of code elements A through Y. When a problem is encountered in the evolving environment (2385), consisting of phases 2387, 2390, 2392, 2393, 2394 and 2395, at phase 2392, the system generates a software module (2310) consisting of elements G1.7 (2320), M2.3 (2330), Q7.1 (2340) and X3.0 (2350). The system applies the solution at 2393. The module (2360) evolves at the next phase to consist of elements D4.1 (2365), J5.8 (2370), K1.1 (2375) and T7.4 (2380) to apply at phase 2395.

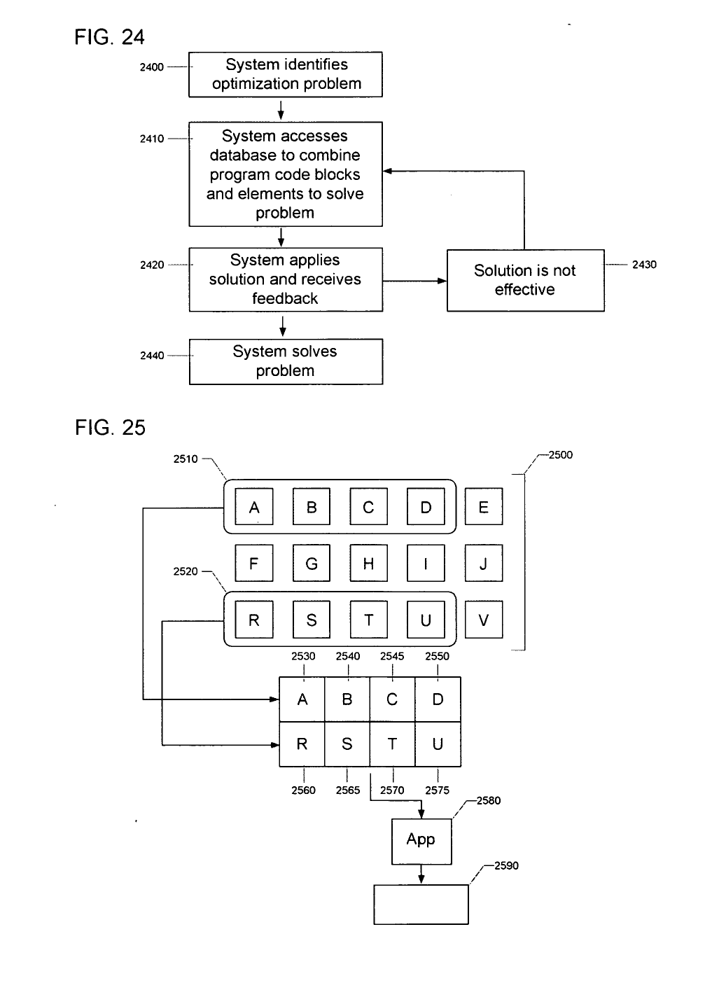

FIG. 24 describes the use of a database to solve an optimization problem with code blocks and elements. The system first identifies an optimization problem (2400) and then accesses a database to combine program code blocks and elements to solve the problem (2410). The system applies a solution and receives feedback (2420). The problem is either solved (2440) or the solution is not effective (2430). If the problem is not effective, the system continues to access the database to combine problem code blocks and elements to solve the problem (2410) and the process continues until the problem is solved.

In FIG. 25, the illustration shows the combination of code element sequences into a software module to apply to a software application. The sequences A, B, C and D (2510) and R, S, T and U (2520) are drawn from the code library (2500) to combine into the software module (2525). The module consists of code elements A (2530), B (2540), C (2540), D (2550), R (2560), S (2565), T (2570) and U (2575). The module is applied to the application (2580), which then is used at 2590.

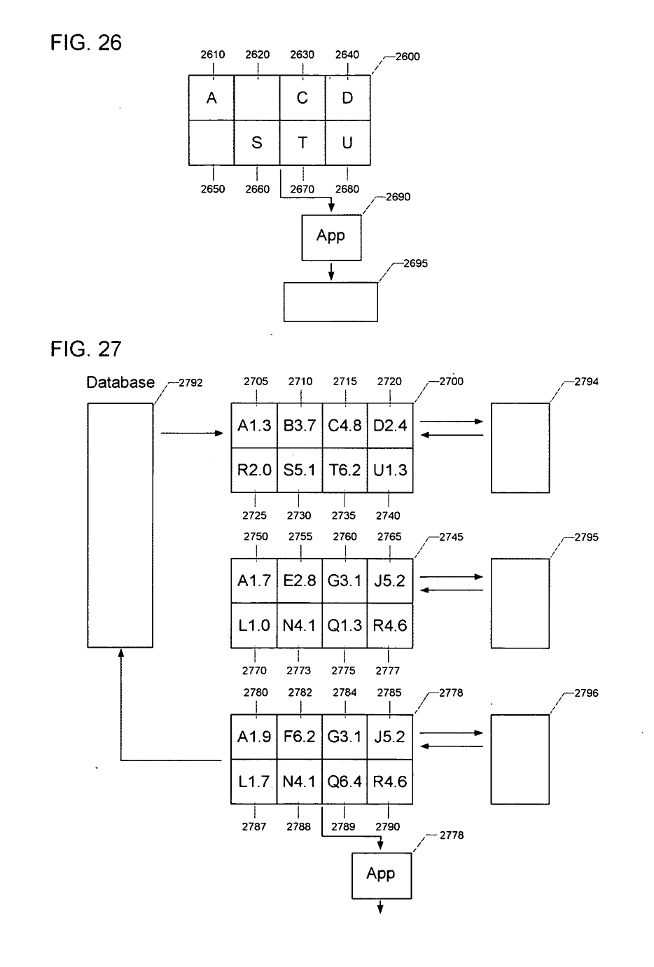

FIG. 26 shows an inactive code module with empty locations that are required to fill like a key in a lock to activate the code to apply to a software application. The software module (2600) consists of code elements A (2610), C (2630), D (2640), S (2660), T (2670) and U (2680) as well as blank spaces (2620 and 2650). The module is then applied to an application (2690) and used at 2695.

FIG. 27 shows the evolution of a solution using code elements with feedback from the environment and the storage of an effective solution in a database. Initially, the software module (2700), consisting of code elements A1.3 (2705), B3.7 (2710), C4.8 (2715), D2.4 (2720), R2.0 (2725), S5.1 (2730), T6.2 (2735) and U1.3 (2740), which draws data from the database (2792), is applied to solve a problem at 2794, receives feedback and evolves into the module at the next phase. At this stage, the software module (2745), consisting of elements A1.7 (2750), E2.8 (2755), G3.1 (2760), J5.2 (2745), L1.0 (2770), N4.1 (2773), Q1.3 (2775) and R4.6 (2777) are applied to solve the problem at 2795. The module then receives feedback and evolves to a third stage. The module (2778) consists of elements A1.9 (2780), F6.2 (2782), G3.1 (2784), J5.2 (2785), L1.7 (2787), N4.1 (2788), Q6.4 (2789) and R4.6 (2790) and interacts with the problem at 2796. The final module solution is then stored in the database (2792) and used in the application 2798.

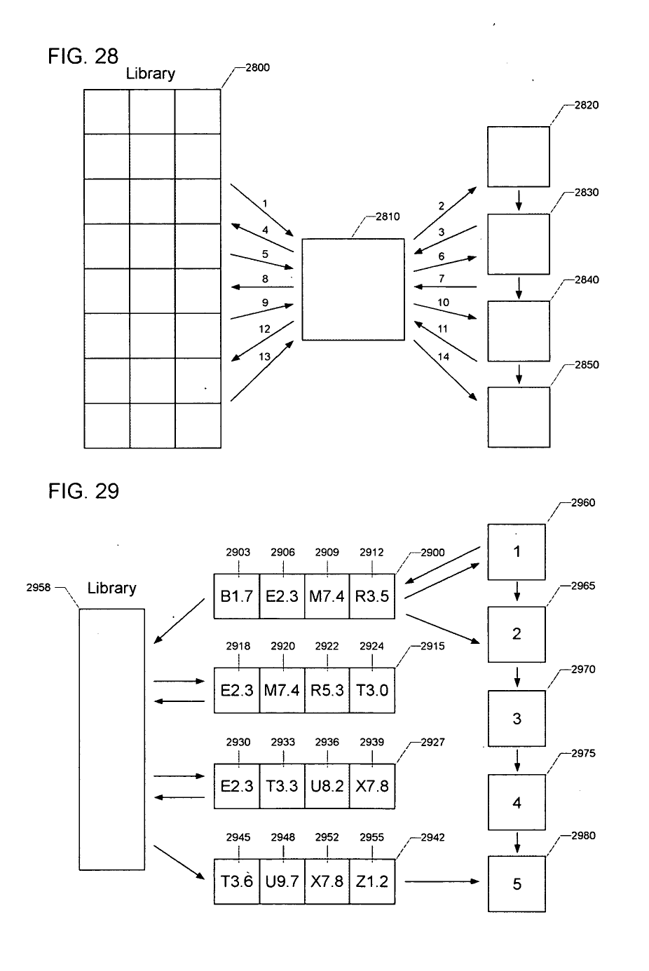

FIG. 28 shows the process of using a software agent to build solutions of code modules from a library to test with an evolutionary environment. The software agent (2810) is used to move data and code elements from the software library (2800) to apply to, and receive feedback from, the evolving problems (2820, 2830, 2840 and 2850) in the environment in a series of sequences delineated in the numbered arrows. In general, the sequence follows the temporal pattern of movement from the library to the environment, back from the environment to the library and so forth until the problem is solved. In this example, there are four phases of problem solving, but the invention is not limited to a set number of phases to the process.

In FIG. 29, the evolutionary process is shown of using code elements to solve a problem by accessing the program code library. In a first phase, the environment at phase 1 (2960) interacts with the system to generate a software module (2900) consisting of program code elements B1.7 (2903), E2.3 (2906), M7.4 (2909) and R3.5 (2912) by accessing the software library (2958). After interacting with the environment, the system applies the module at phase 2 (2965) and adapts the software module (2915) to create a new version consisting of elements E2.3 (2918), M7.4 (2920), R5.5 (2922) and T3.0 (2924) in part by interacting with the library. This process of interaction and adaptation continues as the environment evolves at phases 3 (2970), 4 (2975) and 5 (2980). The module continues to interact with the library and in the next phase the module (2927) consists of elements E2.3 (2930), T3.3 (2933), U8.2 (2936) and X7.8 (2939). In the final phase of this example, the module (2942) consists of elements T3.6 (2945), U9.7 (2948), X7.8 (2952) and Z1.2 (2955). The final version of the module is then applied to solve the problem at phase 5 (2980).

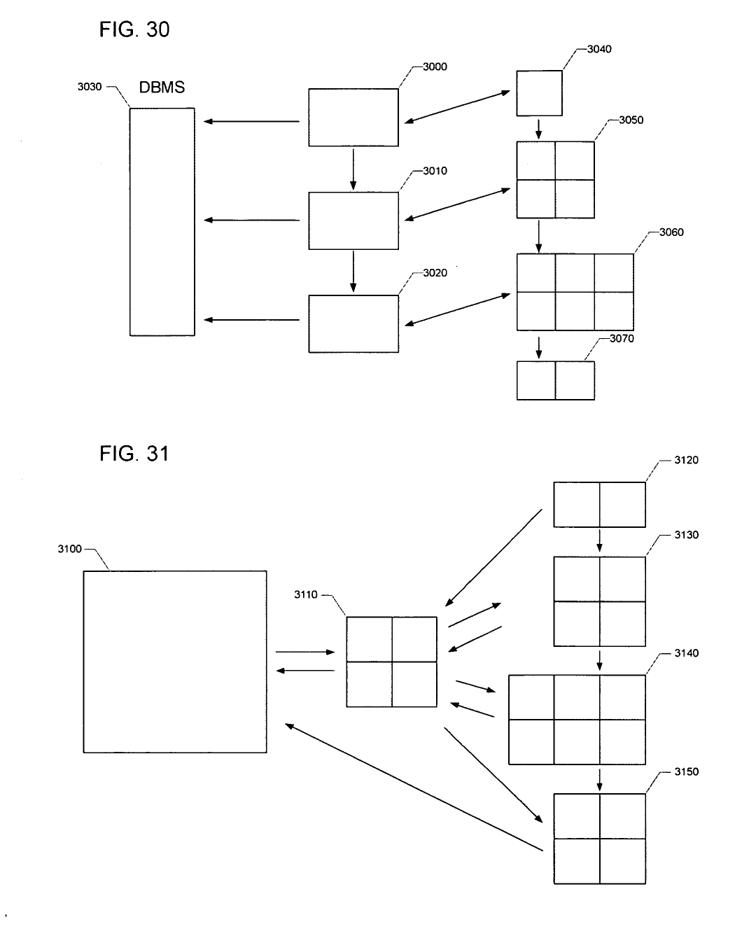

FIG. 30 shows the program code modules interaction with objects as they evolve and store each module version in a database. In the first phase, the software module (3000) interacts with the data object (3040) and stores the data and code in the database (3030). In the next phase, the object evolves (3050) and the software module (3010) interacts with the object and stores the data and code in the database. In the final phase, the object (3060) evolves further and the. software module interacts with the object and stores the data and code in the database. The object finally evolves to a later stage at 3070.

FIG. 31 shows the evolution of an object as a software module tags, registers and stores the data in database tables. The first phase of the object (3120) interacts with the software module (3110), which accesses and stores data in the database (3100). The module continues to interact with the object at the second phase (3130), the third phase (3140) and the fourth phase (3150). The final object is then stored in the database.

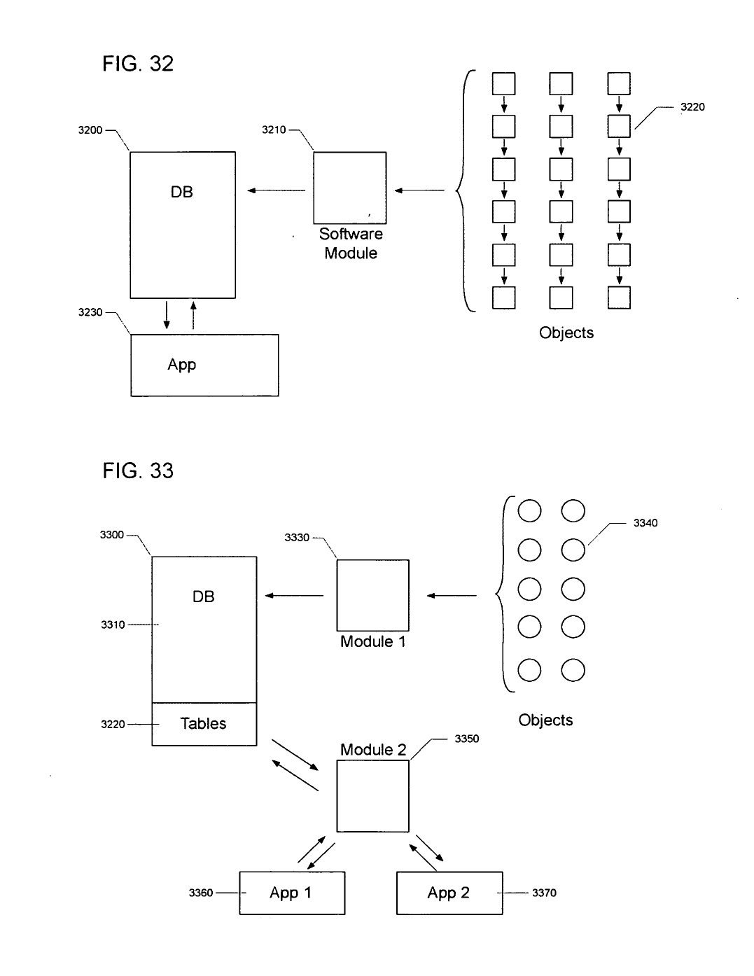

FIG. 32 shows the process of using a software module for filtering, tagging and registering evolving objects in a database for a specific software application. The software module (3210) receives inputs of data objects (3220) and stores the data objects in the database (3200). Applications (3230) then access the database to perform specific tasks.

FIG. 33 shows the process of storing objects in a database by using a software module and applying data to software applications using a software module. In the first phase, module 1 (3330) receives, filters and sorts objects (3340) and stores the data in a database (3300) which contains the data storage component (3310) and data tables (3320). The database is accessed by module 2 (3350), which then applies data to application 1 (3360) and application 2 (3370).

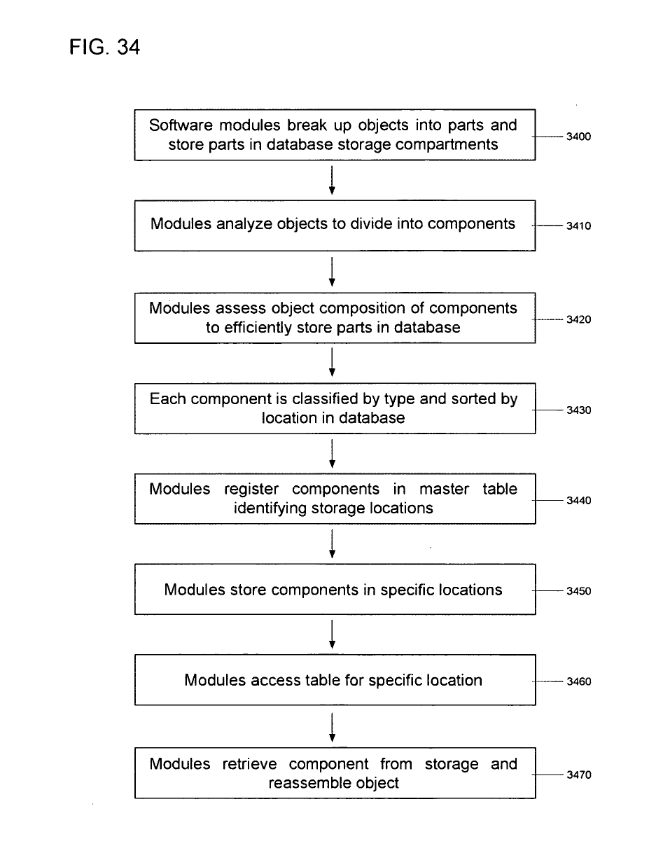

FIG. 34 shows the process of using software modules to analyze and classify objects and store objects in a database. In the first phase, software modules break up objects into parts and store the parts in database storage compartments (3400). The modules then analyze objects to divide into components (3410) and assess object composition of the components to efficiently store pans in the database (3420). Each component is classified by type and sorted by location in the database (3430). The modules register components in a master table identifying storage locations (3440) and the modules then store components in specific locations (3450). The modules access the table for the specific storage location (3460) and the modules then retrieve the component from storage and reassemble the object (3470).

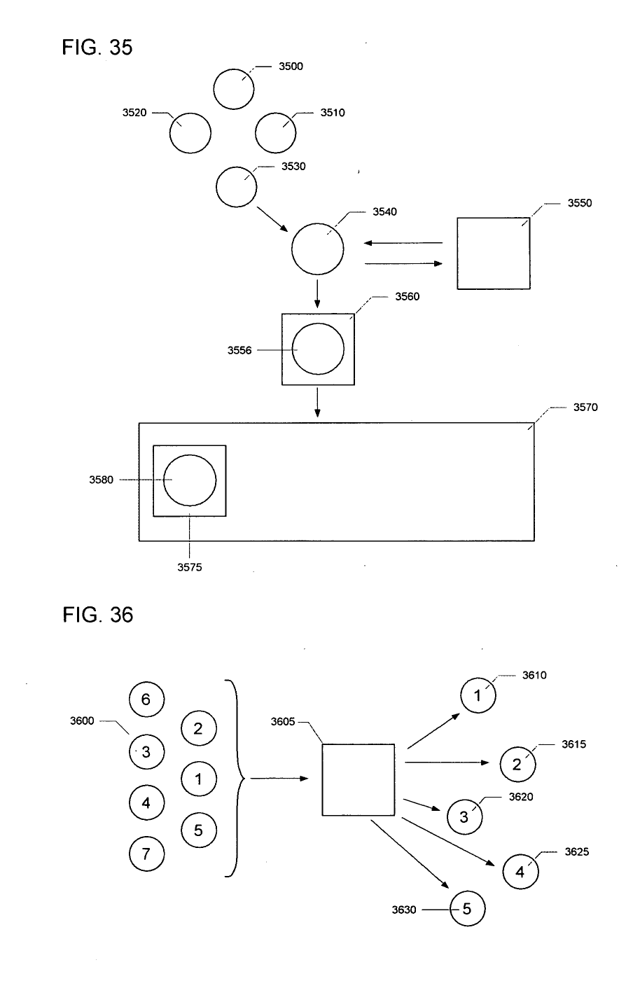

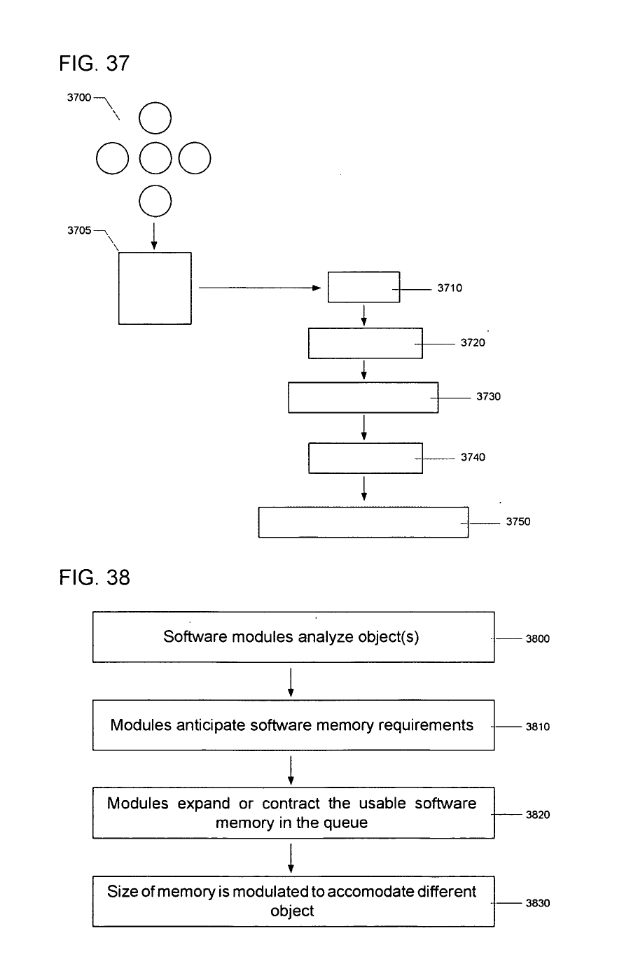

FIGS. 35 to 38 show the process of using software modules to interact with data objects. FIG. 35 shows the process of using a software module to tag and register object components in a database table. Object components (3500, 3510, 3520, 3530 and 3540) interact with a software module (3550) and a component (3560) is tagged (3556) by the module for storage (3580) of the object component (3575) in the database (3570). FIG. 36 shows a software module reordering object components. The object components 1-7 (3600) are ordered randomly and enter the software module (3605), which acts as a filter to reorder the components in an orderly sequence of 1 (3610), 2 (3615), 3 (3620), 4 (3625) and 5 (3630). FIG. 37 shows the software module sorting objects into an elastic queue and storing the objects in a database. The objects (3700) are input into the software module (3705), which outputs the objects in a queue that changes its capacity over time. In the first phase, the queue (3710) is small, but in the second (3720) and third (3730) phases progressively increases capacity. In the next phase, the queue (3740) is constrained and then the objects are stored in the database (3750). FIG. 38 shows the process of using software modules to modify the software memory of an application to organize objects. After the software modules analyze object(s) (3800), the modules anticipate software memory requirements (3810). The modules then expand or contract the usable software memory in the queue (3820) and the size of the memory is modulated to accommodate different objects (3830).

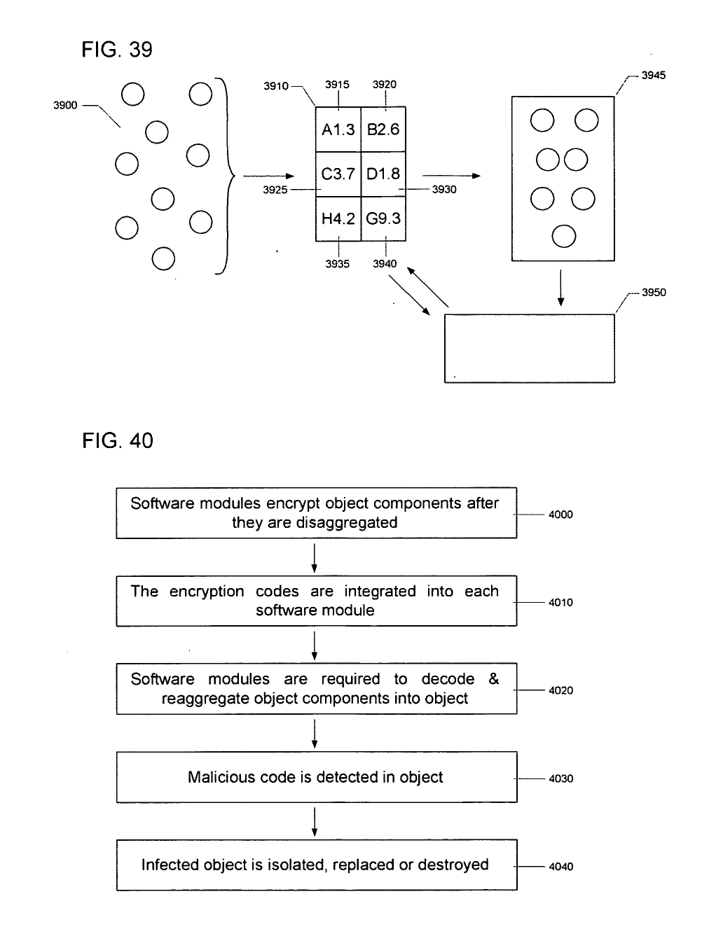

FIG. 39 shows the process of using software modules to encrypt and access objects and object components before they are stored in a database. The objects (3900) are input into the software module (3910), which consists of program code elements A1.3 (3915), B2.6 (3920), C3.7 (3925), D1.8 (3930), H4.2 (3935) and L9.3 (3940). The module encrypts the objects (3945) and stores the encrypted objects in the database (3950). The encrypted objects are then accessed by the module. FIG. 40 shows the process of using software modules to encrypt, decode and reaggregate object components. The software modules encrypt object components after they are disaggregated (4000). The encryption codes are then integrated into each software module (4010) and the modules are required to decode and reaggregate object components into object(s) (4020). If malicious code is detected in the object (4030), the infected object is isolated, replaced or destroyed (4040).

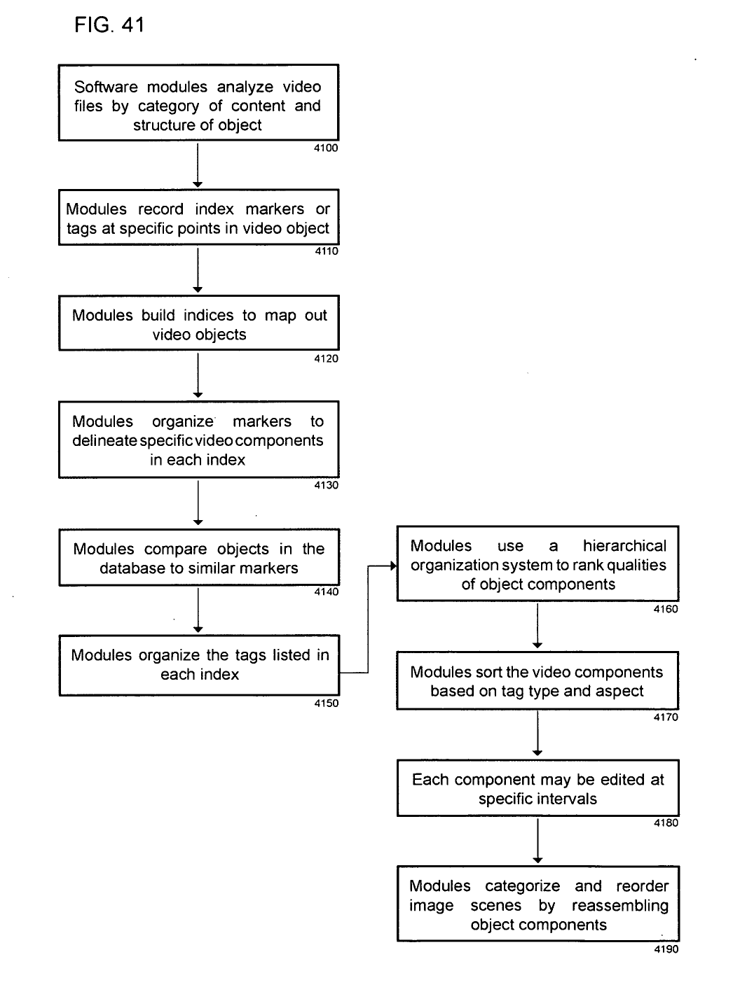

FIG. 41 shows the process of using software modules to analyze, sort, categorize and reorder video object components. After software modules analyze video files by category of content and structure of object (4100), the modules record index markers or tags at specific points in the video object (4110) and modules build indices to map out video objects (4120). The modules organize markers to delineate specific video components in each index (4130) and compare objects in the database to similar markers (4140). The modules organize the tags listed in each index (4150) and modules use a hierarchical organization system to rank qualities of object components (4160). The modules sort the video components based on tag type and aspect (4170) and each component may be edited at specific intervals (4180). The modules then categorize and reorder image scenes by reassembling object components (4190).

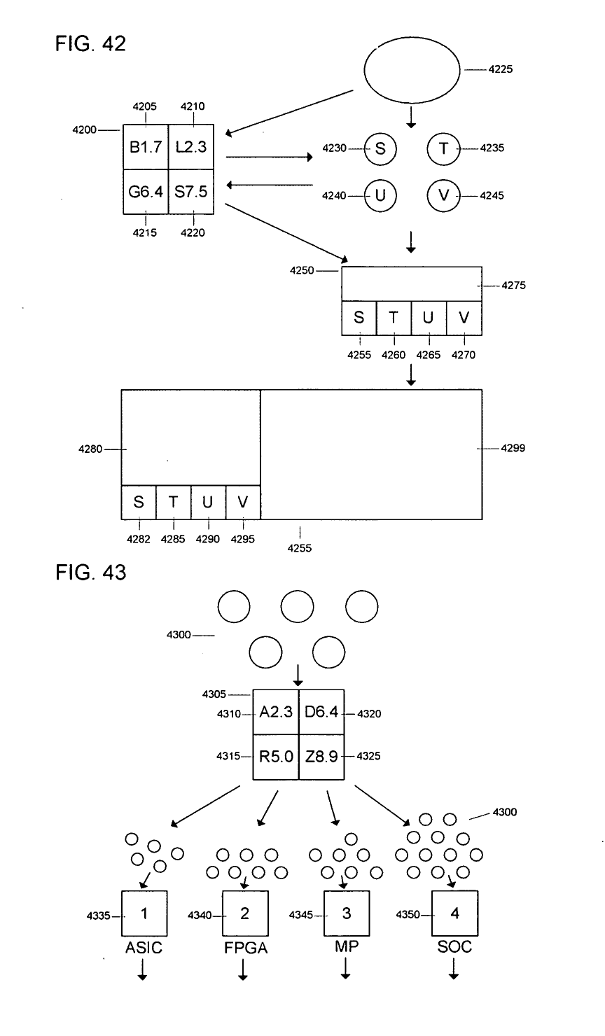

FIG. 42 shows the process of using a software module to decompose an object into components and store the object components in a table and database. The object (4225) is input into the software module (4200), which is comprised of program code elements B1.7 (4205), L2.3 (4210), G6.4 (4215) and S7.5 (4220). The module then decomposes the object into object components S (4230), T (4235), U (4240) and V (4245). The object components (S (4255), T (4260), U (4265) and V (4270)) and software block (4275) interact with the module and are refined and stored in a table (4250). The table is a component of the database (4255). The database consists of the table (4280) that contain the object components (S (4282), T (4285), U (4290) and V (4295) and a storage (4299) compartment.

FIG. 43 shows the process using a software module to divide objects into components and filter and route the components to integrated circuits at different locations. The objects (4300) are input into a software module (4305), which consists of code elements A2.3 (4310), D6.4 (4320), R5.0 (4315) and Z8.9 (4325). The module then decomposes the objects into object components (4330). Each of these components are directed to different circuit types, including an ASIC (4335), an FPGA (4340), a microprocessor (4345) and a system on a chip (4350).

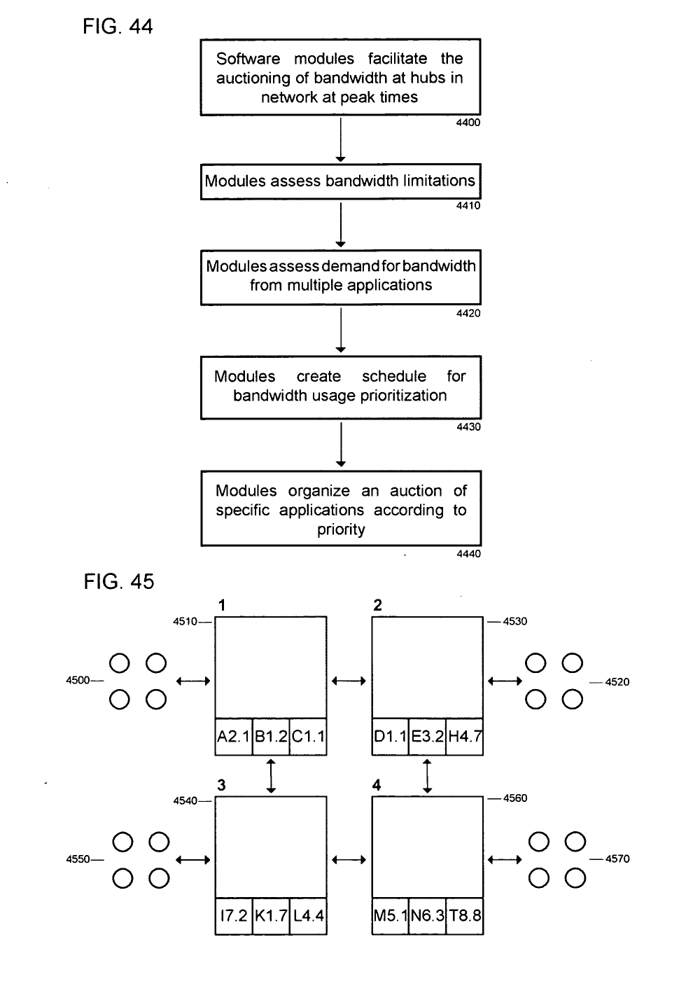

FIG. 44 shows the process of using software modules to facilitate the process of auctioning bandwidth in network hubs at peak times. Software modules facilitate the auctioning of bandwidth at hubs in a network at peak times (4410) by intermediating between the bandwidth demands and the system bandwidth constraints at a specific time. The modules assess the bandwidth limitations (4410) and assess demand for bandwidth from multiple software applications (4420). The modules create a schedule for bandwidth usage prioritization (4430) and organize an auction of specific applications according to priority (4440).

FIG. 45 shows the use of software modules to process data objects in network hubs and routers. In the illustration, four sets of objects (4500, 4520), 4550 and 4570) are processed by four software modules (4510, 4530, 4540 and 4560). Objects at 4500 are processed by module 1 (4510); objects at 4520 are processed by module 2 (4530); objects at 4550 are processed by module 3 (4540) and objects at 4570 are processed by module 4 (4560). The modules are shown linked to each other.

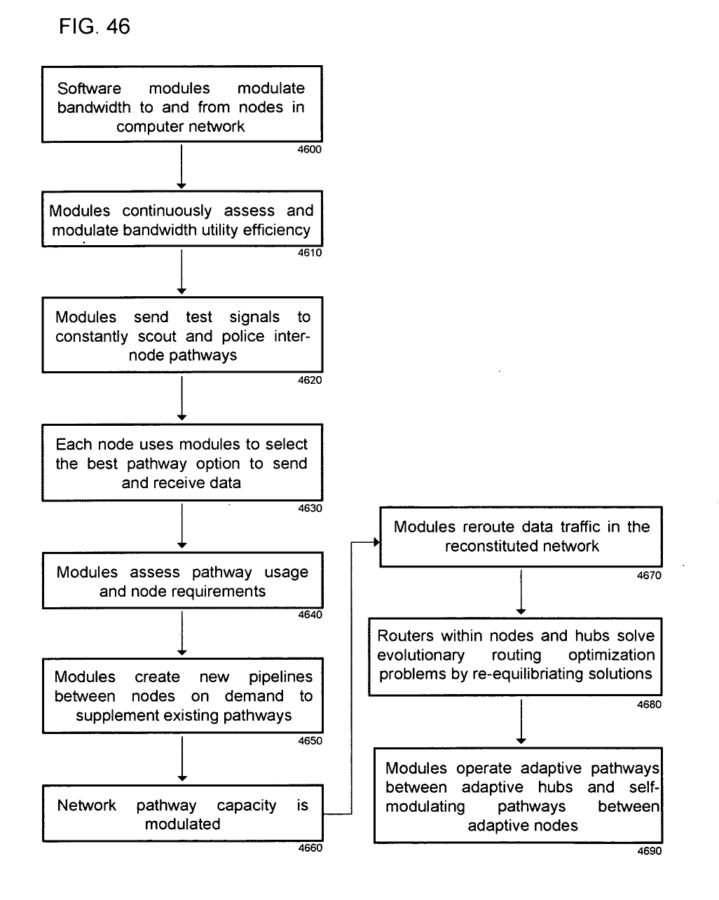

FIG. 46 shows the process of using software modules to manage computer network operations. First, software modules modulate bandwidth to and from nodes in a computer network (4600), continuously assess and modulate bandwidth utility efficiency (4610) and then send test signals to constantly scout and police inter-node pathways (4620). Each node uses modules to select the best pathway option to send and receive data (4630) and modules assess pathway usage and node requirements (4640). The modules create new pipelines between nodes on demand to supplement existing pathways (4650) and network pathway capacity is modulated (4660). The modules then reroute data traffic in the reconstituted network (4670). The routers within nodes and hubs solve evolutionary routing optimization problems by re-equilibrating solutions (4680). The modules operate adaptive pathways between adaptive hubs and self-modulating pathways between adaptive nodes (4690).

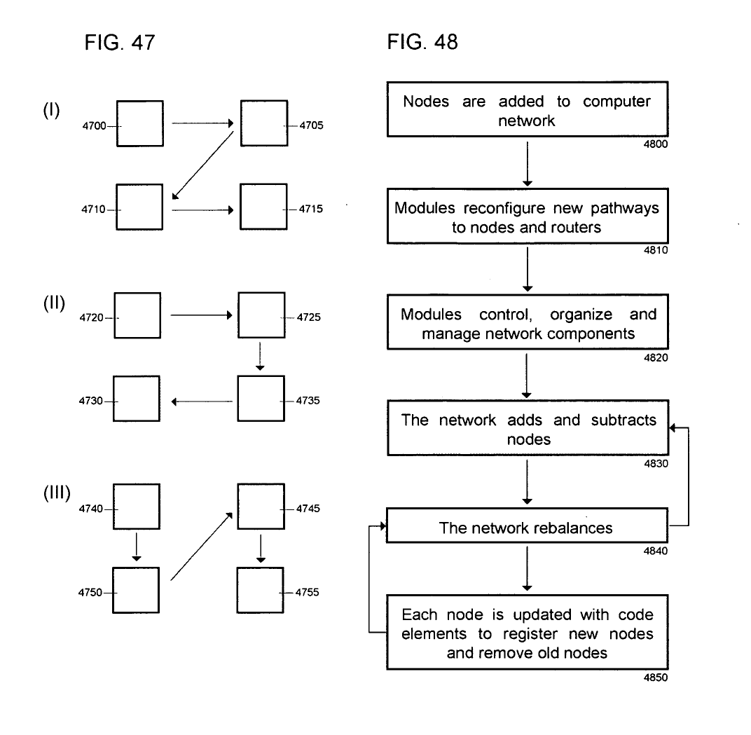

FIG. 47 shows the rerouting of nodes during three phases using software modules. In the first phase, node 4700 forwards data to node 4705, which forwards data to node 4710, which forwards data to node 4715. In the second phase, the node at 4720 forwards data to the node at 4725, which then forwards data to the node at 4735, which then forwards the data to node 4730. In the third phase, the node at 4740 forwards data to the node at 4750, which forwards data to the node at 4745, which forwards data to the node at 4755. The software modules are used in the nodes to receive data, analyze the data and determine the routing of data to specific nodes. In this example, the nodes forward data to other nodes in different orders determined by using the software modules based on solutions to multi-objective optimization constraints factors, such as time, location, priority and peak usage, with a goal to maintain maximum network efficiency.

FIG. 48 shows the process of using software modules to manage network components. Once nodes are added to a computer network (4800), the software modules reconfigure new pathways to nodes and routers (4810). Modules control, organize and manage network components (4820) and the network adds and subtracts nodes (4830). The network then rebalances (4840) by continuing to add and subtract nodes as requested until each node is updated with code elements to register new nodes and remove old nodes (4850).

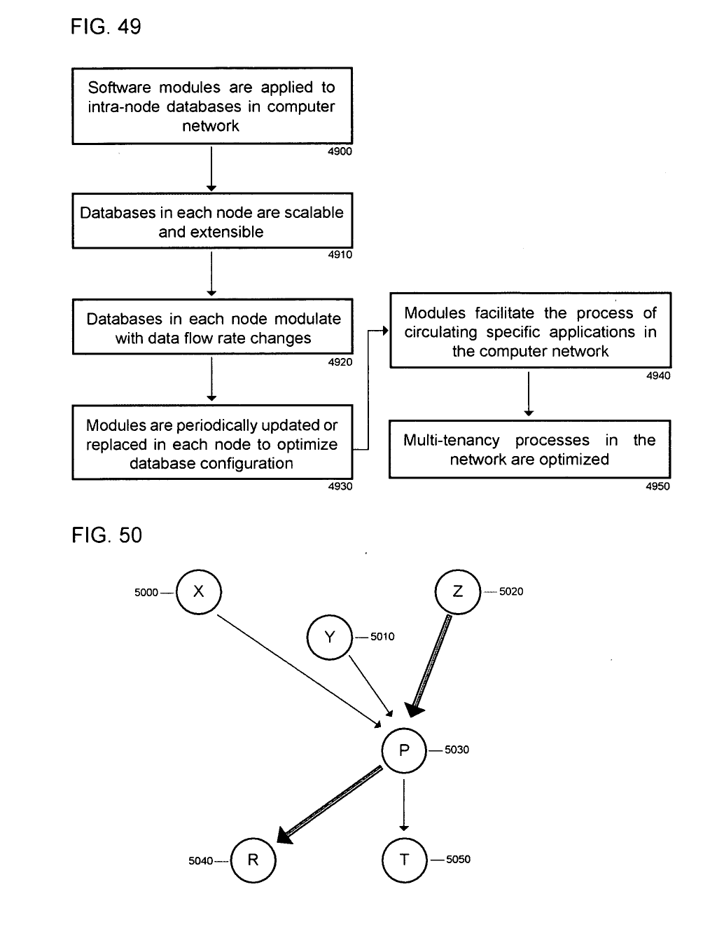

FIG. 49 shows the process of applying software modules to databases in a Computer network. After software modules are applied to intra-node databases in a computer network (4900), databases in each node are scalable and extensible (4910) and modulate with data flow rate changes (4920). Modules are periodically updated or replaced in each node to optimize database configuration (4930) and the modules facilitate the process of circulating specific applications in the computer network (4940). The effect of these phases is to optimize the network multi-tenancy processes (4950).

FIG. 50 shows the process of attracting modules to a problem node to move an object from one node to another node. Software modules X (5000), Y (5010) and Z (5020) are attracted to the problem node P (5030). While objects are passed from node P to nodes R (5040) and T (5050), objects are moved from Z (5020) through P (5030) to node R (5040) to solve a problem.

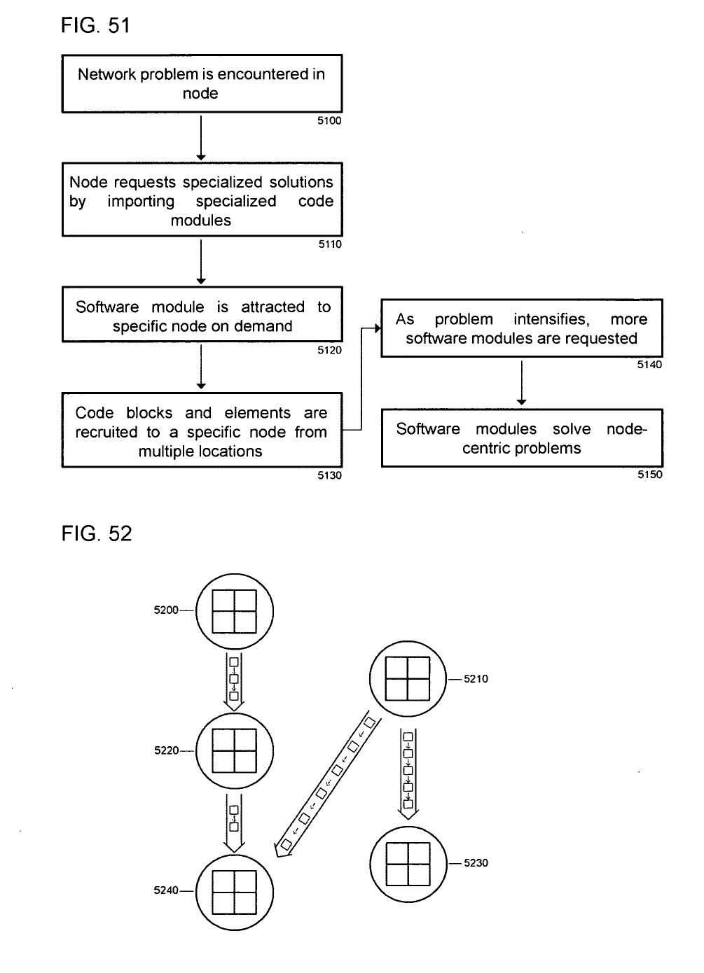

FIG. 51 shows the process of solving a network node problem using software modules. After a network problem is encountered in a node (5100), the node requests specialized solutions by importing specialized code modules (5110) and a software module is attracted to a specific node on demand (5120). Code blocks and elements are recruited to a specific node from multiple locations (5130) and, as the problem intensifies, more software modules are requested (5140) until the software modules solve node-centric problems (5150).

FIG. 52 shows the process of moving modules in parallel nodes. The modules are shown in the nodes (5200, 5210, 5220, 5230 and 5240). In this example, modules are passed from node 5200 to node 5220, from nodes 5210 and 5220 to node 5240 and from node 5210 to node 5230.

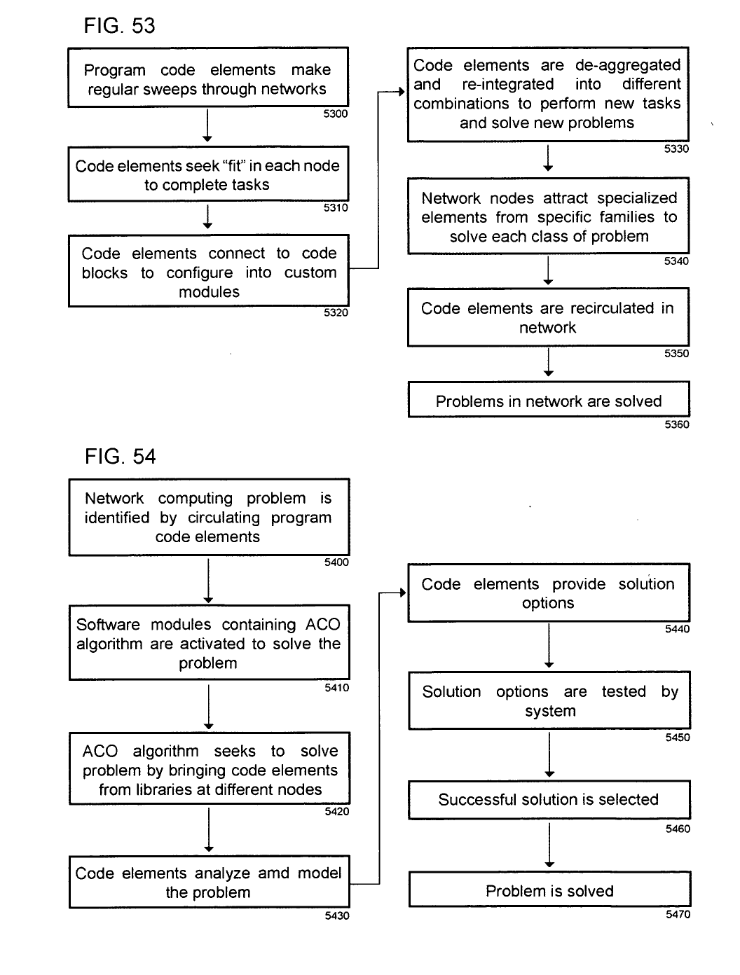

FIG. 53 shows the process of combining program code elements to solve problems in a computer network. Once program code elements make regular sweeps through the network (5300), the code elements seek a “fit” in each node to complete tasks (5310). The elements connect to code blocks to configure into custom modules (5320) and the elements are de-aggregated and re-integrated into different combinations to perform new tasks and solve new problems (5330). The network nodes attract specialized elements from specialized families to solve each class of problem (5340) and code elements are recirculated in the network (5350) until the network problems are solved (5360).

FIG. 54 shows the process of applying the ACO algorithm to software modules to solve a network computing problem. After a network computing problem is identified by circulating program code elements (5400), software modules containing the ACO algorithm are activated to solve the problem (5410). The ACO algorithm seeks to solve the problem by bringing code elements from software libraries at different nodes (5420) and the code elements then analyze and model the problem (5430). The code elements provide solution options (5440) and the solution options are tested by the system (5450). The successful solution is selected (5460) and the problem is solved (5470).

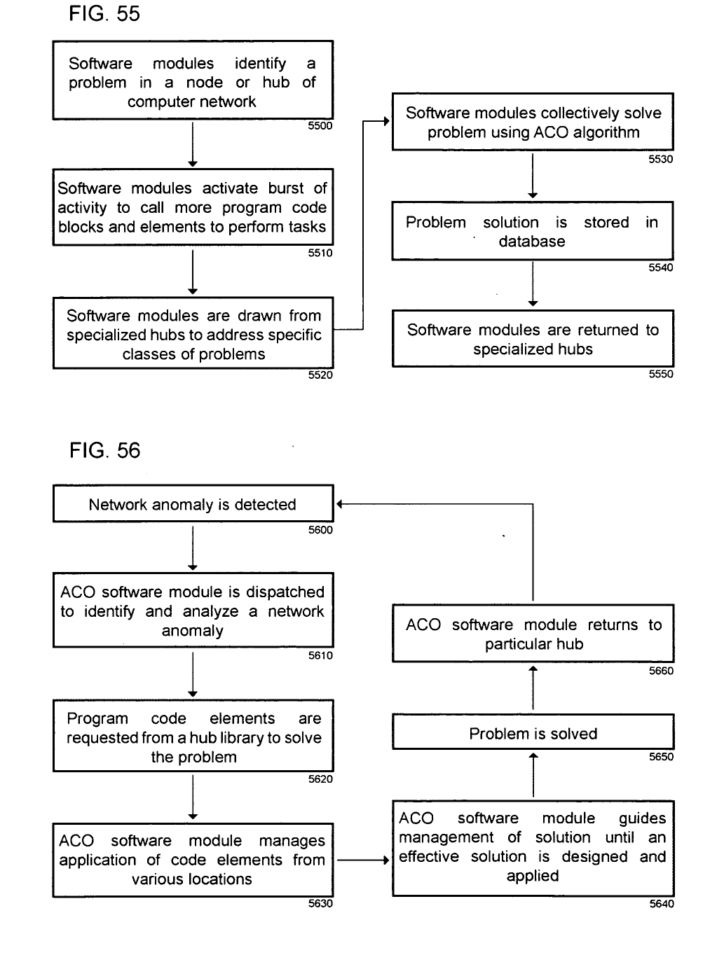

FIG. 55 shows the process of using specialized software modules to solve a network computing problem using the ACO algorithm. Once the software modules identify a problem in a node or hub of the computer network (5500), the modules activate a burst of activity to call more program code blocks and elements to perform tasks (5510). The software modules are drawn from specialized hubs to address specific classes of problems (5520) and the modules collectively solve the problem using the ACO algorithm (5530). The problem solution is then stored in a database (5540) and the software modules are returned to specialized hubs (5550).

FIG. 56 shows the process of using software modules that apply the ACO algorithm to analyze and solve a network computing problem. After a network anomaly is detected (5600), the ACO software module is dispatched to identify and analyze the anomaly (5610). The program code elements are requested from a hub library to solve the problem (5620) and the ACO software module manages application of code elements from various locations (5630). The ACO software module guides management of the solution until an effective solution is designed and applied (5640) and the problem is solved (5650). The ACO software module then returns to a particular hub (5660) and the process continues as new anomalies are detected.

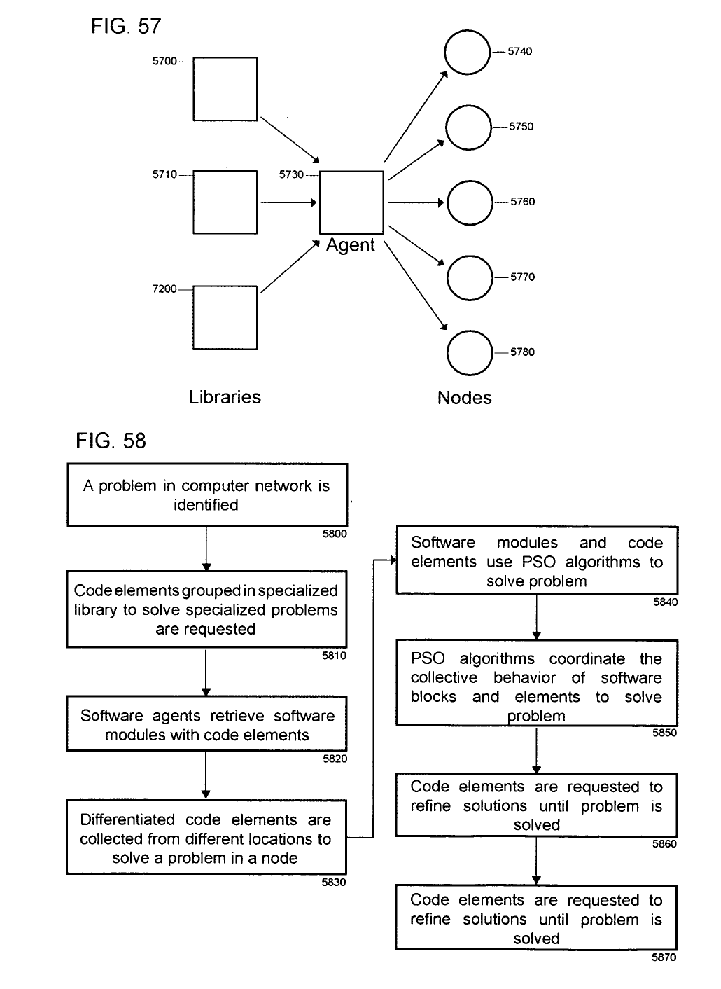

FIG. 57 shows the use of a software agent to move code from libraries to network nodes. The software agent (5730) receives program code blocks and elements from libraries (5700, 5710 and 5720) at different locations and, after processing the code modules and components, forwards the code modules and components to multiple nodes (5740, 5750, 5760, 5770 and 5780) in the network.

FIG. 58 shows the process of using program code elements and software agents to apply the PSO algorithm to solve network computing problems. After a problem in a computer network is identified (5800), code elements grouped in specialized software libraries to solve specialized problems are requested (5810). Software agents retrieve software modules with code elements (5820) and differentiated code elements are collected from different locations to solve a problem in a node (5830). The software modules and code elements use PSO algorithms to solve the problem (5840) and the PSO algorithms coordinate the collective behavior of software blocks and elements to solve a problem (5850). The code elements are requested to refine solutions until the problem is solved (5860) and the problem solving process in the computer network is automated by using the software modules and software agents (5870).

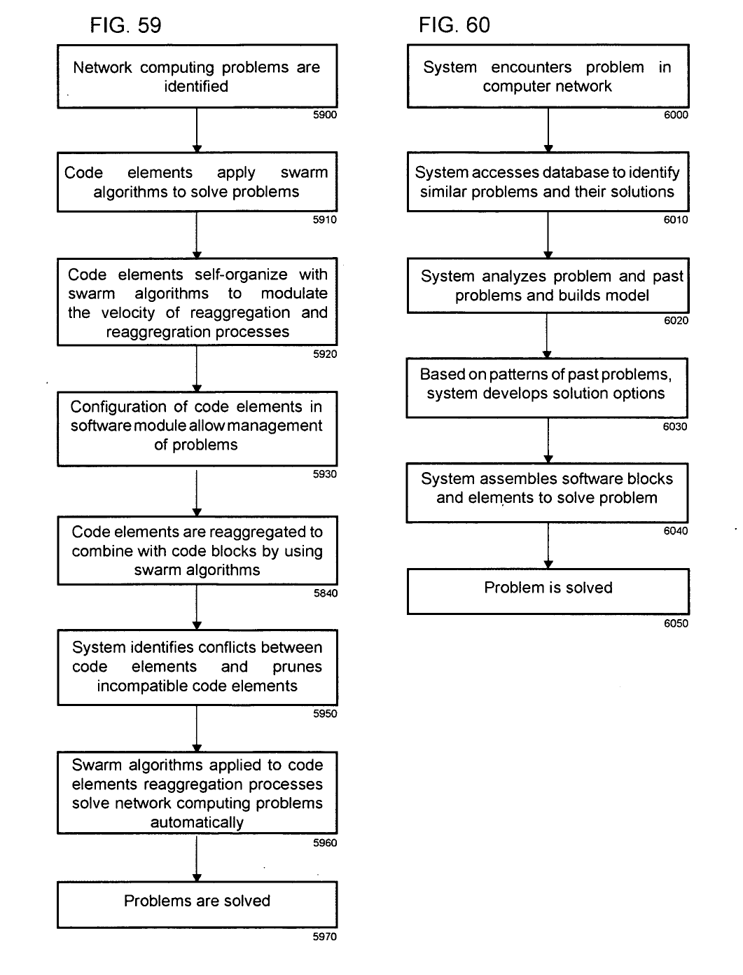

FIG. 59 shows the process of applying swarm algorithms to self-organizing code elements to solve network computing problems. Once the network computing problems are identified (5900), code elements apply swarm algorithms to solve the problems (5910). The code elements self-organize with swarm algorithms to modulate the velocity of aggregation and reaggregation processes (5920). The configuration of code elements in a software module allows the management of problems through the management and organization of data (5930). The code elements are reaggregated to combine with code blocks by using swarm algorithms (5940) and the system identifies conflicts between code elements and prunes incompatible code elements (5950). The swarm algorithms applied to code element reaggregation processes solve network computing problems automatically (5960) and the problems are solved (5970).

FIG. 60 shows the process of using code modules to solve a network computing problem. After the system encounters a problem in a computer network (6000), the system accesses a database to identify similar problems and their solutions (6010). The system analyzes the problem and past problems and builds a model (6020). Based on patterns of past problems, the system develops solution options (6030) and the system assembles software blocks and elements to solve the problem (6040) until the problem is solved (6050).

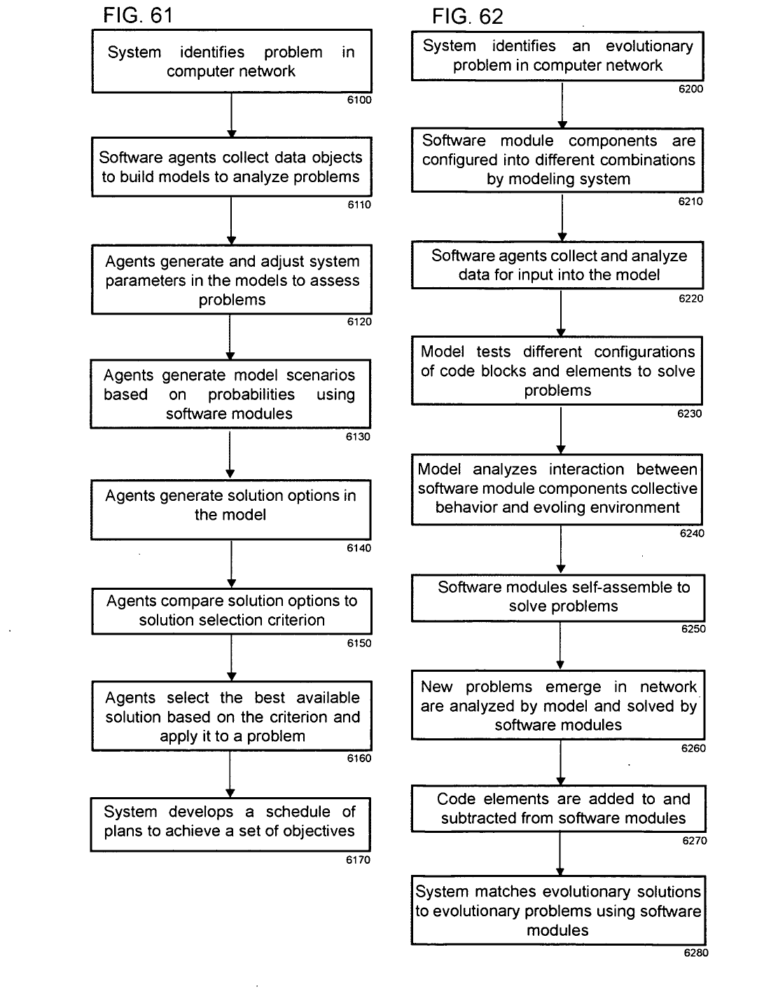

FIG. 61 shows the process of using software agents to build models using software modules to solve a network computing problem. After the system identifies a problem in the computer network (6100), software agents collect data objects to build models to analyze the problem(s) (6110). The agents generate the model and adjust system parameters in the model(s) to assess problem(s) (6120) and then generate model scenarios based on probabilities using software modules (6130). The agents generate solution options in the model (6140), compare solution options to solution selection criterion (6150) and then select the best available solution based on the criterion and apply it to a problem (6160). The system develops a schedule of plans to achieve a set of objectives (6170).

FIG. 62 shows the process of using software agents to facilitate the self-assembly of code modules to solve an evolutionary problem in a computing network. The system identifies an evolutionary problem in a computer network (6200) and software module components are configured into different combinations by modeling the system (6210). Software agents collect and analyze data for input into the model (6220) and the model tests different configurations of code blocks and elements to solve problems (6230). The model analyzes interaction between software module components collective behavior and the evolving environment (6240). Software modules then self-assemble to solve problems (6250). As new problems emerge in the network, they are analyzed by the model and solved by applying the software modules (6260). The code elements are added to and subtracted from software modules (6270) in order to solve the problems. The system matches evolutionary solutions to evolutionary problems using software modules (6280).

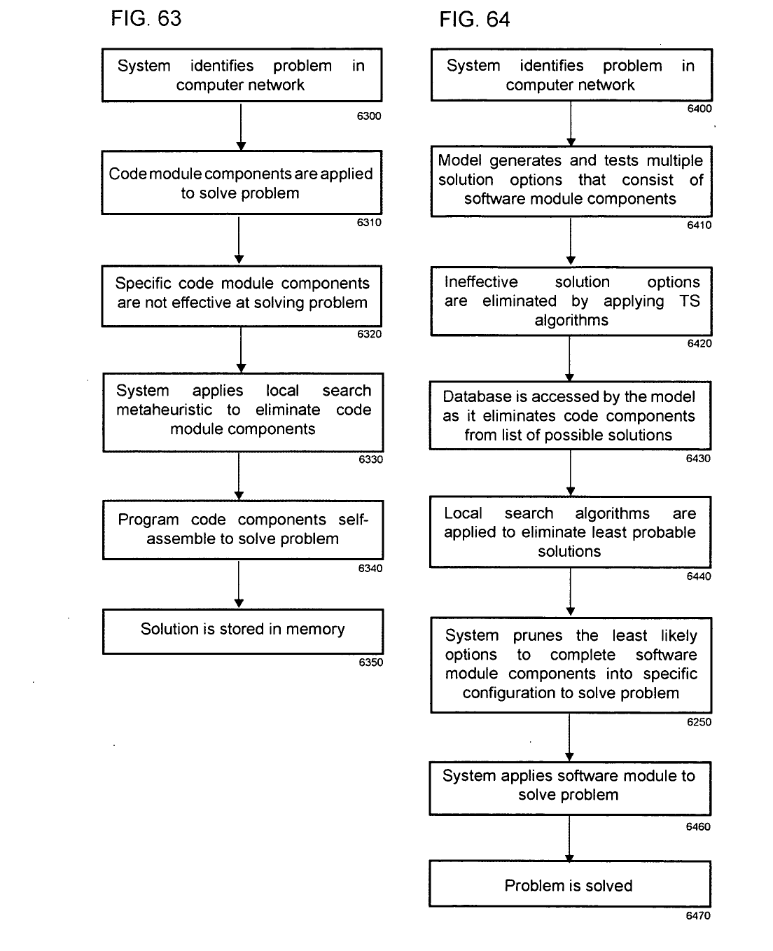

FIG. 63 shows the process of applying a local search metaheuristic to software module components to solve a network computing problem. After the system identifies a problem in a computer network (6300), code module components are applied to solve the problem (6310). If specific code module components are not effective at solving the problem (6320), the system applies local search metaheuristic to eliminate unnecessary or previously used and ineffective code module components (6330). The program code components then self-assemble to solve the problem (6340) and the solution is stored in memory (6350).

FIG. 64 shows the process of applying the TS algorithm to software modules to solve a network computing problem. After the system identifies a problem in a computer network (6400), a model generates and tests multiple solution options that consist of software module components (6410). Ineffective solution options are eliminated by applying TS algorithms (6420) and a database is accessed by the model as it eliminates code components from the list of possible solutions (6430). The local search algorithms are applied to eliminate least probable solutions (6440) and the system prunes the least likely options to complete software module components into specific configuration to solve the problem (6450). The system applies the precisely configured software module to solve the problem (6460) and the problem is solved (6470).

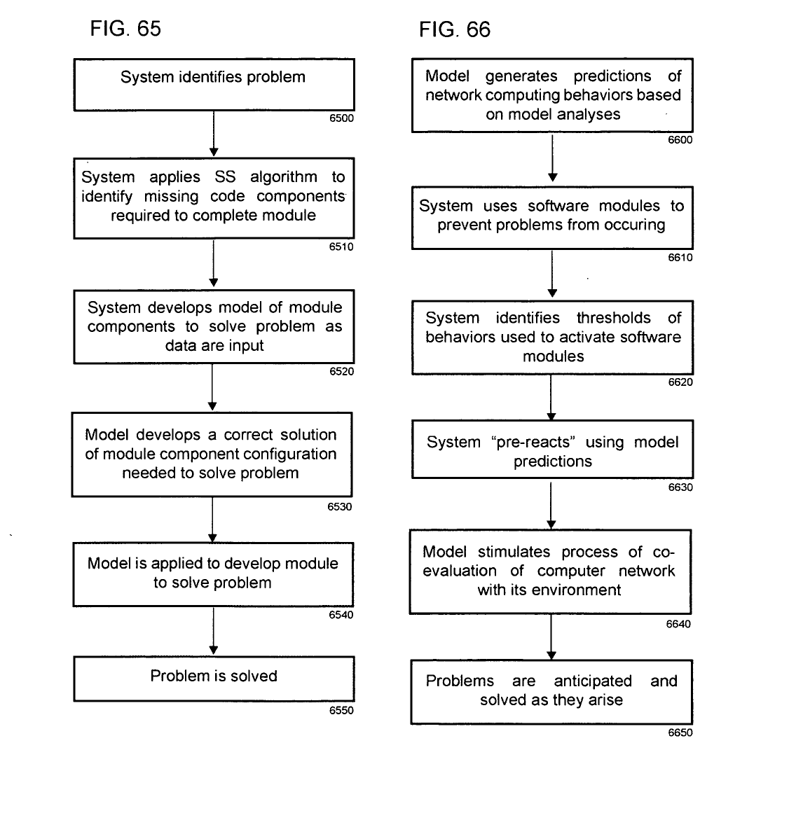

FIG. 65 shows the process of applying the SS algorithm to software modules to solve a network computing problem. The system identifies a problem (6500), applies the SS algorithm to identify missing code components required to complete the module (6510) and develops a model of module component aggregation configurations to solve the problem as data are input (6520). The model develops a correct solution of module component configuration needed to solve the problem (6530) and the model is applied to develop a software module to solve the problem (6540) until the problem is solved (6550).

FIG. 66 shows the process of using software modules to solve a co-evolutionary network computing problem. After the model generates predictions of network computing behaviors based on model analyses (6600), the system uses software modules to prevent problems from occurring (6610) and the system identifies thresholds of behaviors used to activate software modules (6620). The system “pre-reacts” using model predictions (6630) and the model stimulates the process of co-evolution of the computer network with its environment (6640). The problems are anticipated and solved as they arise (6650).

I claim:

1. A method to configure program code in a computer comprising:
a program code block consisting of a set of instructions;
program code elements each consisting of a sequence of instructions;
a digital computer organized to process the instructions;
a database organized to store the instructions;
data objects organized to be stored in and retrieved from the database;
wherein the program code block is configured to process data objects in the computer, the method consisting of;
configuring a program code block to perform specific tasks to process data objects in the computer;
accessing the database with a program code block and elements to retrieve and store data objects; and
aggregating the program code elements to perform specific tasks by processing the instructions and objects in the computer.

2. A method of claim 1, further comprising the step of:
combining the program code elements to create a specific configuration; and
organizing the program code elements in a specific configuration to solve a specific computer problem.

3. A method of claim 1, further comprising the step of:
self-assembling the program code elements into a specific configuration in response to a specific computer problem; and
solving the computer problem by applying the self-assembled configuration of program code elements.

4. A method of claim 1, further comprising the step of:
Using the program code elements to interact with an evolving environment; and
self-organizing the program code elements into a configuration to solve a computer problem.

5. A method of claim 4, further comprising the step of:
receiving feedback from the environment;
updating each element with a new element version; and
combining the program code elements into a specific configuration to solve the computer problem.

6. A method of claim 1, further comprising the step of:
combining the program code elements into a specific configuration;
identifying a problem in a computer network; and
self-assembling the program code elements into a specific configuration to solve the computer network problem.

5. A system to configure program code in a computer, comprising:
a program code block consisting of a set of instructions;
program code elements each consisting of a sequence of instructions;
a digital computer organized to process the instructions;
a database organized to store the instructions;
data objects organized to be stored in and retrieved from the database;
wherein the program code block is configured to process data objects in the computer by accessing the database; and
wherein the program code elements are configured to aggregate to perform specific tasks by processing the instructions and objects in the computer.

7. A system of claim 5, wherein:
the program code elements are combined to create a specific configuration; and
the program code elements are organized to solve a specific computer problem.

8. A system of claim 5, wherein:
the program code elements are self-assembled into a specific configuration in response to a specific computer problem; and
the computer problem is solved by applying the self-assembled configuration of program code elements.

9. A system of claim 5, wherein:
the program code elements interact with an evolving computer environment;
the program code elements self-organize into a specific configuration to solve a computer problem;
a new version of each element is created in order to update each element; and
the program code elements are combined into a specific configuration to solve the computer problem.

10. A system of claim 5, wherein:
the program code elements are combined into a specific configuration;
a problem is identified in a computer network; and
the program code elements are self-assembled into a specific configuration to solve the computer network problem.

11. A computer program product to organize program code blocks and elements, such code stored on a computer readable storage medium, executable by an electronic circuit with the following system architecture having a plurality of system layers interconnected to one another, comprising:
A hardware level consisting of a semiconductor layer, a node layer in a computer network, a hub layer in a computer network and distributed hubs in a computer network;
A data storage level consisting of data objects, a single database management system and a distributed database management system;
A software level consisting of software modules, program code blocks and program code elements; and
A system dynamics level consisting of an evolving environment, task feedback from the computer network and environment, multi-node plasticity and a reconfigurable network architecture with evolving software modules.
